(19) United States
(12) Patent Application Publication
(10) Pub. No.: US 2010/0223922 A1
(43) Pub. Date: Sep. 9, 2010

(54) "Closed Loop" Economy of Motion Machine

(76) Inventor: Welbourne D. McGahee, Melbourne, FL (US)

Correspondence Address: Vincent dePaul McGahee, 402 Twin Timbers Lane, Kemah, TX, 77565, US

(21) Appl. No.: 12/380,801

(22) Filed: Mar. 5, 2009

(51) Int. Cl. F03B 17/02

(52) U.S. Cl. 60/495

(57) ABSTRACT

A means and apparatus for fluid containment providing for closed loop operation of an apparatus within a column of liquid. The apparatus extracts power from a buoyant source within the contained column of liquid and is comprised of an endless chain of movable buoyant objects, a means to convert the movement of the chain into useful work and a tank filled with a constant volume column of liquid. The buoyant objects comprising the chain sequentially enter the bottom of the liquid column through an airlock seal of the current invention, move up through the column and emerge at the surface. The emerging buoyant objects leave the tank and are directed to the tank bottom where each buoyant object repeats the cycle. As the chain of buoyant objects cycles through the displaced column of liquid, the volume of liquid remains constant, with one buoyant object of the chain entering the bottom of the liquid column as one is exiting at the top surface. The invention provides for closed loop operation of the apparatus and increased control fluid flow rates within the apparatus to addresses liquid leakage due to mechanical wear at seals and to provide a controlled method for removal of friction generated heat within the apparatus. Chambered sections within the apparatus create fluid flow restriction zones where differential pressure can be controlled to further reduce the force requirement for injecting each buoyant object (a.k.a. displacing element) into the bottom of the contained column of liquid.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO A “SEQUENCE LISTING”

Not applicable.

### BACKGROUND OF THE INVENTION

(1) Field of the Invention

The invention relates to a method and apparatus for producing energy without creating pollution or using any known consumables currently employed to produce energy. It is an advancement of the art for extracting energy as a function of the relative density between an object and a working fluid as described in the parent U.S. Pat. No. 7,434,396.

(2) Discussion of the Relevant Art

Water has always been used by man for centuries to generate useful work and create energy. This has always been accomplished as a function of gravity induced motion of the water. The earliest known devices were water wheels which have evolved into modern hydroelectric systems employing massive dams. These devices require a steady source of flowing water, thus are very inefficient, since potential energy is lost as water flows past the paddles or turbines vanes behind the mass of water causing the paddle wheel or turbine vanes to move and before the next paddle or vane is in position to be fully engaged by the flowing water. More recently, tide machines have been used to create energy by displacement. The displacement in such devices is not of water but of a buoyant device. Water has only been thought of as a means to float something, i.e. a displacer. Displacement of liquid was done from the top down and this displacement is what causes the displacer to be lifted in a tide machine where the displacer is less dense than the liquid.

Even more recently, a breakthrough in displacement practices was achieved with the Economy of Motion Machine, U.S. Pat. No. 7,434,396 issued on Oct. 14, 2008 to Welbourne Dawson McGahee, whereby displacement is held constant while a chain of buoyant objects move up in the displaced liquid column. Upon emerging from the liquid column the chain of displacing elements passes out of the liquid tank and over an idle wheel. Simultaneously, the chain of displacers passes around a second idle wheel and by way of an airlock, return into the bottom of the liquid column. This goes on as long as desired. Either or both idle wheels may drive an electric generator or directly power a machine requiring a rotary input driving means. Alternatively, work may be extracted from the moving chain as from a linear escapement motor. The present invention is related to parent U.S. Pat. No. 7,434,396 and is an advancement of the art in that it provides for continuous closed loop operation of the apparatus and for variable modes of operation.

### OBJECTIVES OF THE INVENTION

The principle objective of the present invention is to provide a closed loop system for the apparatus depicted in FIG. 1 of U.S. Pat. No. 7,434,396, which is used for producing power from the effective buoyancy of a constrained object immersed in a liquid to produce energy without consuming any and all types of combustible fuels to perform useful work, with said closed loop system providing for the complete isolation of the apparatus internals from the outside environment, thereby also preventing working fluid losses from the apparatus into the environment.

Another objective is to increase the functionality of the airlock, depicted in FIG. 2 of U.S. Pat. No. 7,434,396, to provide a means of adjusting the mode of operation for the apparatus in the event adjustable seals become worn and are leaking excessively.

A primary objective is to increase the production of power from energy resulting from the differential density between a solid and a liquid by providing the means to control and manipulate working fluid flow rates throughout the system thereby beneficially influencing the internal fluid dynamics to reduce the force required to inject a buoyant object into the displaced column of liquid i.e. provide the ability to create differential pressure zones, balance forces across seals, decrease the density of the working fluid within the primary airlock assembly, create turbulence in localized regions to beneficially disrupt laminar flow paths.

A still further objective is to increase the availability for service factor by increasing the efficiency of the adjustable seals, thereby generating useful work for longer periods of time.

Another objective is to improve the removal of friction generated heat from within the apparatus, thereby minimizing unwanted density fluctuations within the displaced liquid column, thus ensuring that the buoyant properties of the displacing elements are fully utilized to generate maximum useful work.

Another objective is to provide an additional method for transferring fluids back into the top of the contained liquid column, while at the same time reducing the flow rate of liquid exiting the displaced liquid column and minimizing any liquid leakage through the airlock.

Another objective is to provide an alternative means of returning any liquid, which may leak past the airlock chamber, back into the contained liquid column without the use of a conventional liquid pump assembly.

Another objective is to provide a novel alternative for liquid sealing utilizing a liquid differential seal, at the entrance to the bottom of the tank containing the displaced liquid column, with said liquid seal able to adjust the seal opening size (horizontal adjustment) and adjust the vertical position of the seal opening in respect to the bottom opening of the tank.

Other objectives and advantages will become apparent as the disclosing of these improvements to the art are considered with the accompanying drawings.

### BRIEF SUMMARY OF THE INVENTION

The “Closed Loop—Economy of Motion Machine” adheres to the original spirit of the parent patent “Economy of Motion Machine” as set forth in U.S. Pat. No. 7,434,396, where liquid displacement is held constant while a chain of buoyant objects move up in the displaced liquid column.

In the “Closed Loop” Economy of Motion Machine, tanks, airlocks and enclosure vessels have been integrally connected to fully encapsulate all apparatus internals. The invention provides the functionality for closed loop operation of the apparatus while maintaining the volume of displaced liquid column constant, thus ensuring that the internals of the apparatus are not exposed to the outside environment during normal operation. This closed loop system inhibits liquid and vapor losses to the environment, while preventing the outside environment from contaminating the apparatus internals. In addition, piping circuits with associated control valves provide the means for controlling working fluid flow rates within the system to both recover fluid that would normally escape from the apparatus into the outside environment and to compensate for any increase in liquid leak rate at the seals due to frictional forces and associated mechanical wear over time. Chambered equipment internals are configured to provide fixed tolerance clearances, while adjustable seals and the aforementioned piping circuits allow for variable control of internal fluid dynamics in order to achieve and maintain the desired differential pressures across the equipment internals, thereby lessening the force required to inject each buoyant object into the column of displaced liquid which in turn increases the operating factor and energy output of the apparatus. Furthermore, a liquid pump is not required during normal operation, since a controlled variable stream of gas can be injected into the primary airlock cavity to increase seal efficiency by improving control of the differential pressure across the air lock seal and as said gas rises it carries entrained liquid upward through liquid riser piping circuits; the rising working fluid is routed back to the top of the liquid column via the overhead liquid recycle tank. Any liquid that manages to pass by the airlock seal is routed into a liquid collection tank placed lower than the airlock; this liquid can be transferred back into the overhead liquid recycle tank either by compressed gas or using a conventional liquid pump assembly. A liquid pump is provided as the auxiliary means for liquid transfers during startup of the apparatus and in the event compressed gas is no longer available as the motive force for liquid transfers.

### BRIEF DESCRIPTION OF THE SEVERAL VIEWS OF THE DRAWINGS

FIG. 1 is a cutaway view of the Economy of Motion Machine, as copied from FIG. 1 of the parent U.S. Pat. No. 7,434,396, illustrating the Major components thereof.

FIG. 2 illustrates the chain of displacers entering the liquid column, as copied from FIG. 2 of the Parent U.S. Pat. No. 7,434,396.

FIG. 3 is a top view of the seal assembly from inside the original liquid tank, as copied from FIG. 3 of the Parent U.S. Pat. No. 7,434,396.

FIG. 3A is a top view of the seal assembly from inside the liquid tank, as it is depicted in the present patent.

FIG. 3B is a cutaway view of a novel alternative self actuating liquid seal design, illustrating the components that make up one embodiment of the liquid differential seal (a.k.a. self actuating floating iris seal).

FIG. 3C is a cutaway view of the self actuating liquid seal design, illustrating the position of the aperture as it forms about the linkage between displacers as the displacing elements travel upward into the liquid column.

FIG. 3D is a cutaway view of the self-actuating liquid seal design, illustrating the position of the aperture as it closes about the linkage between displacers.

FIG. 3E is a cutaway view of a novel alternative liquid seal design, illustrating the components that make up the variable tension iris seal.

FIG. 4 is the view of the air deflector that was previously located inside the contained liquid column as copied from FIG. 4 of the Parent U.S. Pat. No. 7,434,396.

FIG. 5 is a cutaway view of the center of the “Closed Loop” Economy of Motion Machine in the present invention, illustrating the major components thereof.

FIG. 5A is a cutaway view of the upper portion of the closed loop apparatus, including the upper idle wheel enclosure vessel, overhead liquid restriction chamber, vacuum recovery system, overhead liquid alignment sleeve, overhead liquid recycle tank, mechanical bellows dampeners and illustration of the chain of displacers as they exit the top of the displaced liquid tank, enter the overhead liquid recycle tank, engage then disengage the upper idle wheel and as they enter the gravity tube.

FIG. 5B is a cutaway view of the upper center portion of the present invention illustrating the recycle gas system, liquid recovery, liquid recycle accumulator, vent risers, liquid downcomers, and showing how welded platforms are attached to the idle wheel support beams and surrounding support structure to form levels or floors where external equipment can be installed between the idle wheel support beams and floor levels.

FIG. 5C is a cutaway view of the lower center portion of the present invention, including a portion of the lower idle wheel enclosure vessel, portion of the lower idle wheel, secondary airlock assembly, primary airlock assembly, mechanical bellows dampeners, seal gas system and illustrates the chain of displacers as they enter the lower idle wheel enclosure vessel, exit the enclosure vessel and enter the liquid column through the primary airlock assembly.

FIG. 5D is a cutaway view of the lower portion of the present invention, including the bottom portion of the lower idle wheel enclosure vessel, lower idle wheel, illustrating one of the two liquid collection tanks with associated piping and control valves, gas diffuser plate and the chain of displacers as they engage and disengage the lower idle wheel.

FIG. 6 is a detail view of one embodiment of the oblate spheroid displacing element and linkage connecting assembly.

FIG. 6A is a detail view of the linkage assembly for the oblate spheroid displacing elements.

FIG. 6B is an exploded view of the linkage assembly for a typical oblate spheroid displacing element.

FIG. 7 is the view of one of the two idler wheel support beams, which also serve as the primary supports for the entire structure of the apparatus.

FIG. 7A is an overhead view of the upper idle wheel with the enclosure lid removed, thus upper bearing race removed.

FIG. 7B is a view of the lower idle wheel as it looks from underneath the wheel looking upward with the lower enclosure vessel cutaway and the lower bearing race removed.

FIG. 8 is a view of the “Closed Loop” Economy of Motion Machine from the outside as it would appear in an industrial setting.

FIG. 9 is an exploded cutaway view of the top of the displaced liquid tank, overhead liquid restriction chamber, overhead liquid alignment sleeve and mechanical bellows dampener.

FIG. 9A is a cutaway view of the top of the upper idle wheel enclosure vessel showing how the upper enclosure vessel ring flange is mounted to the overhead recycle liquid tank ring flange.

FIG. 9B is an exploded cutaway view of the mechanical bellows dampener on the gravity side of the upper idle wheel located at the top of the overhead liquid recycle tank showing the welded tubular section that attaches to the top of the gravity tube.

FIG. 10 is an exploded cutaway view of the secondary airlock assembly and associated mechanical bellows dampener.

FIG. 11 is an exploded cutaway view of the primary airlock assembly and associated mechanical bellows dampener in the present invention, illustrating the assembly orientation of the components that make up said assembly.

FIG. 12 is a cutaway view of the primary airlock assembly and associated mechanical bellows dampener in the present invention, illustrating the components as assembled.

### DETAILED DESCRIPTION OF THE PREFERRED EMBODIMENT OF THE INVENTION

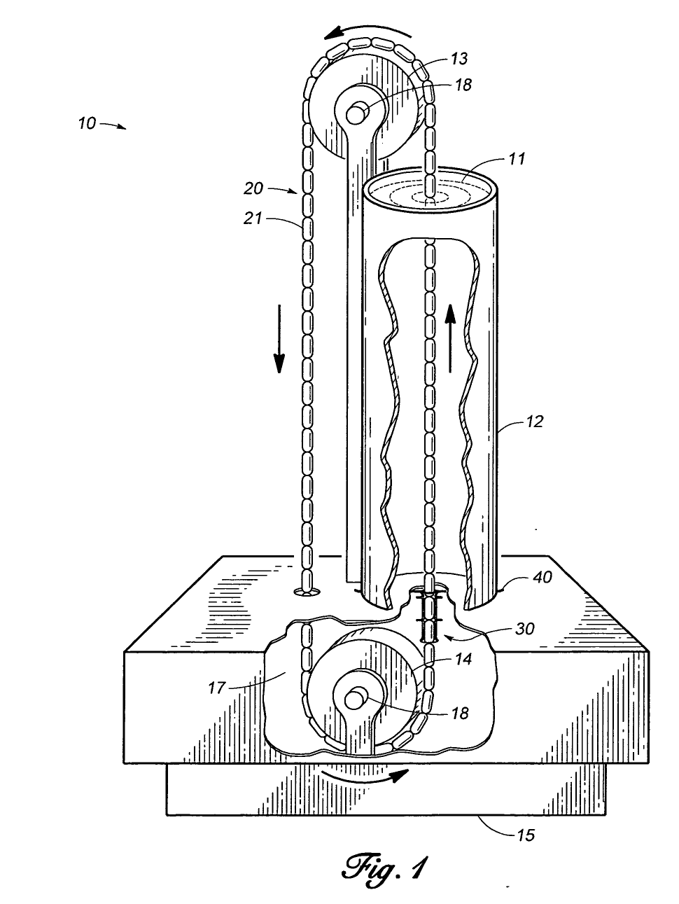

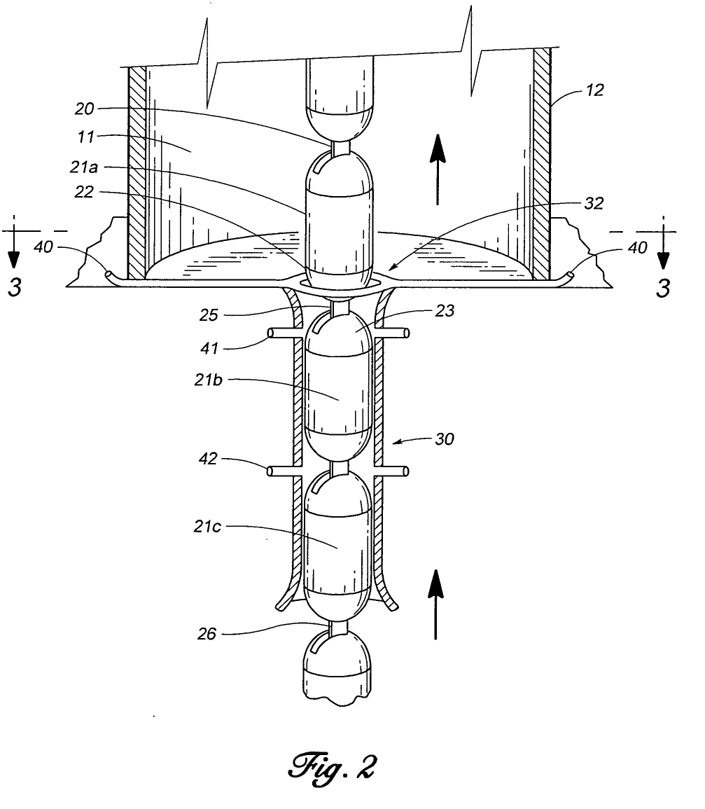

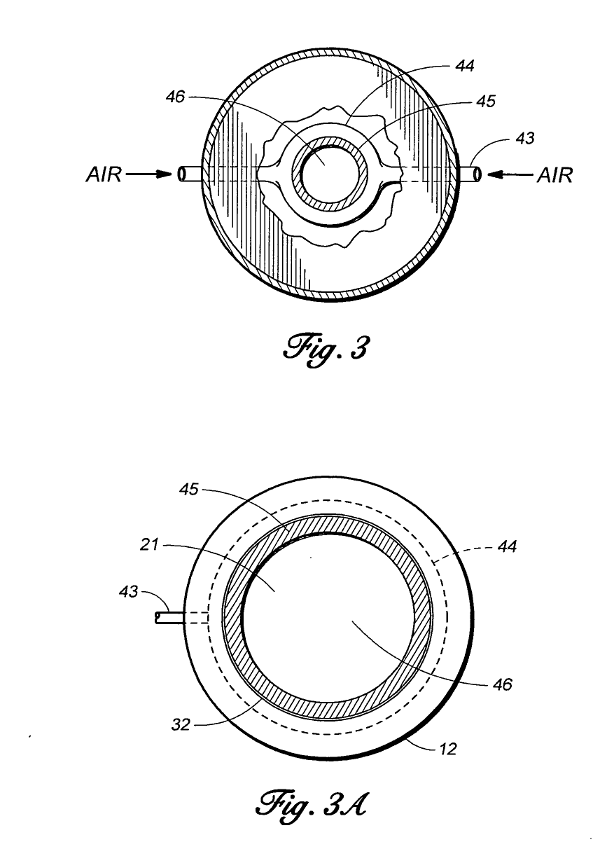

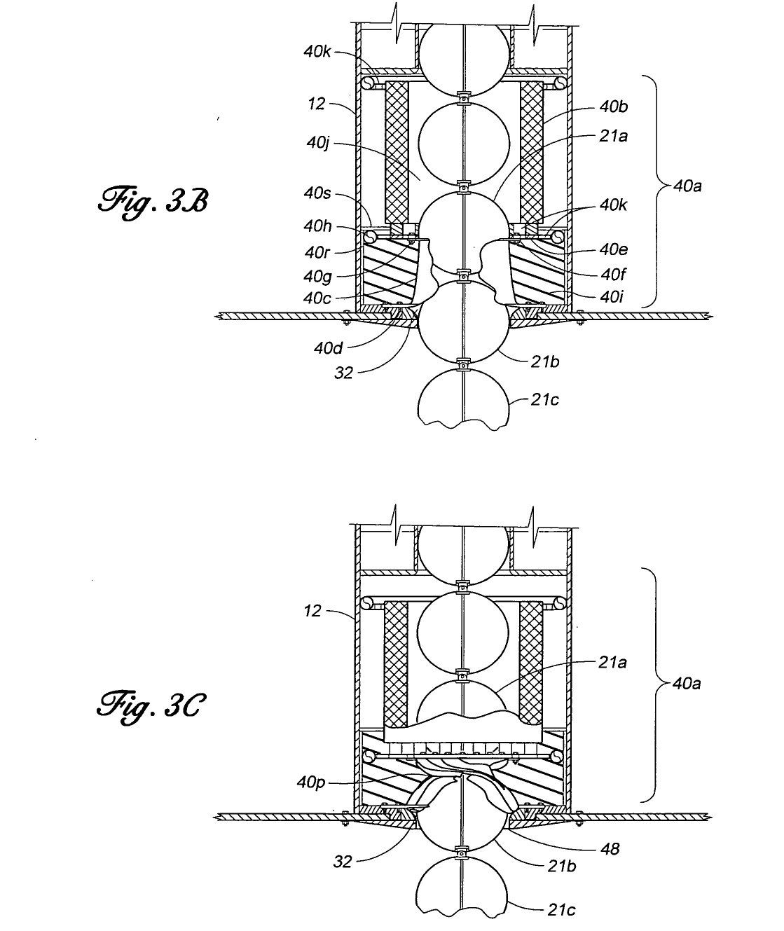

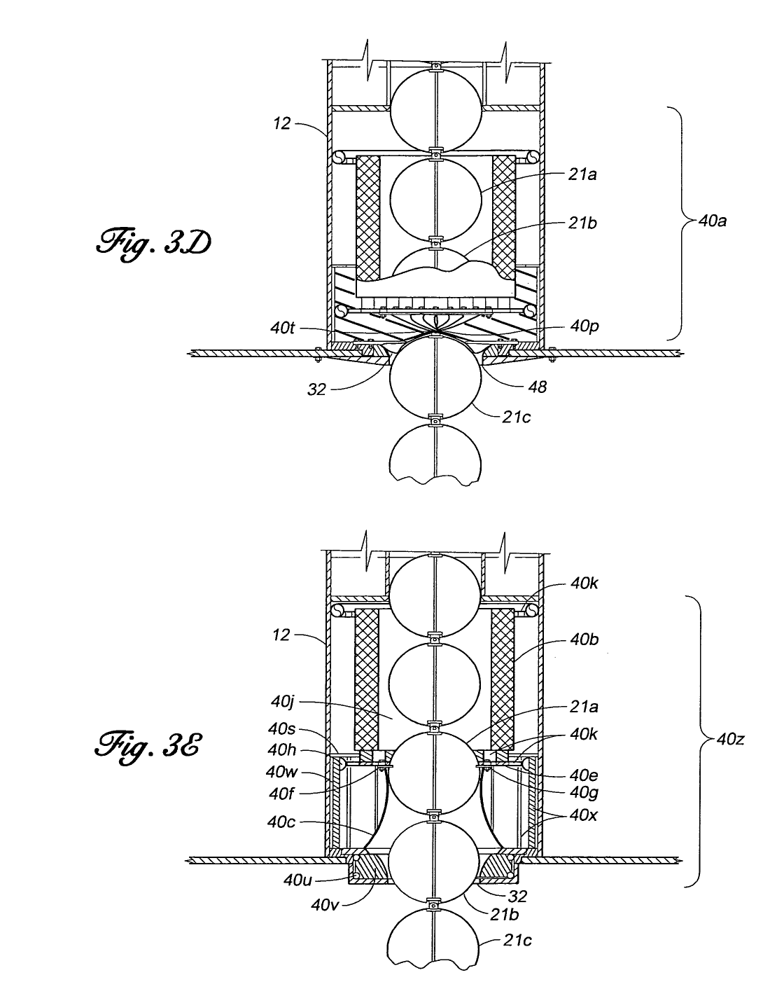

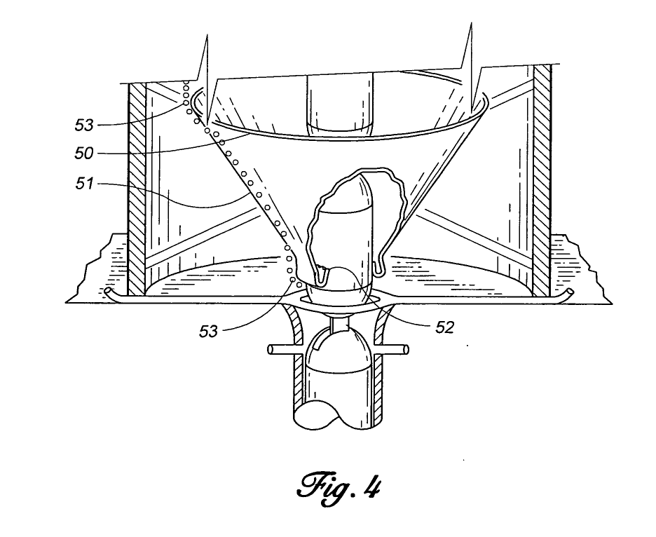

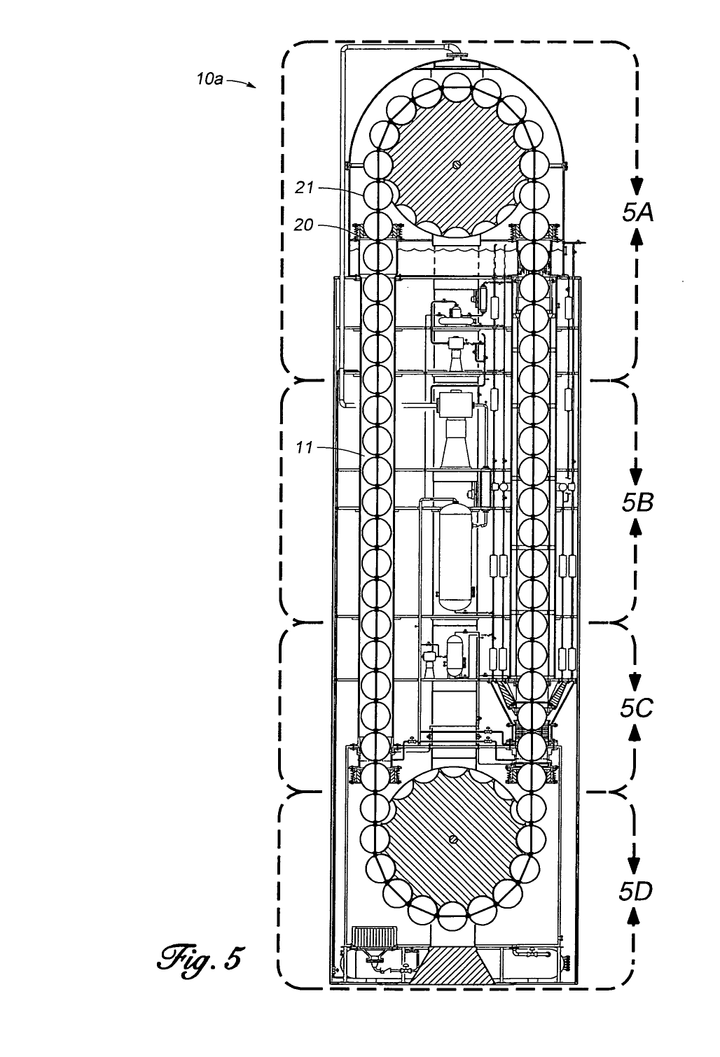

Referring more particularly to the drawings wherein similar reference characters designate like parts throughout the several reviews. FIG. 1, FIG. 2, FIG. 3, and FIG. 4 are provided for the purpose of cross referencing changes made to the parent patent and all reference characters shown in FIG. 1, FIG. 2, FIG. 3, and FIG. 4 are likewise used in all other associated drawings of the preferred embodiment.

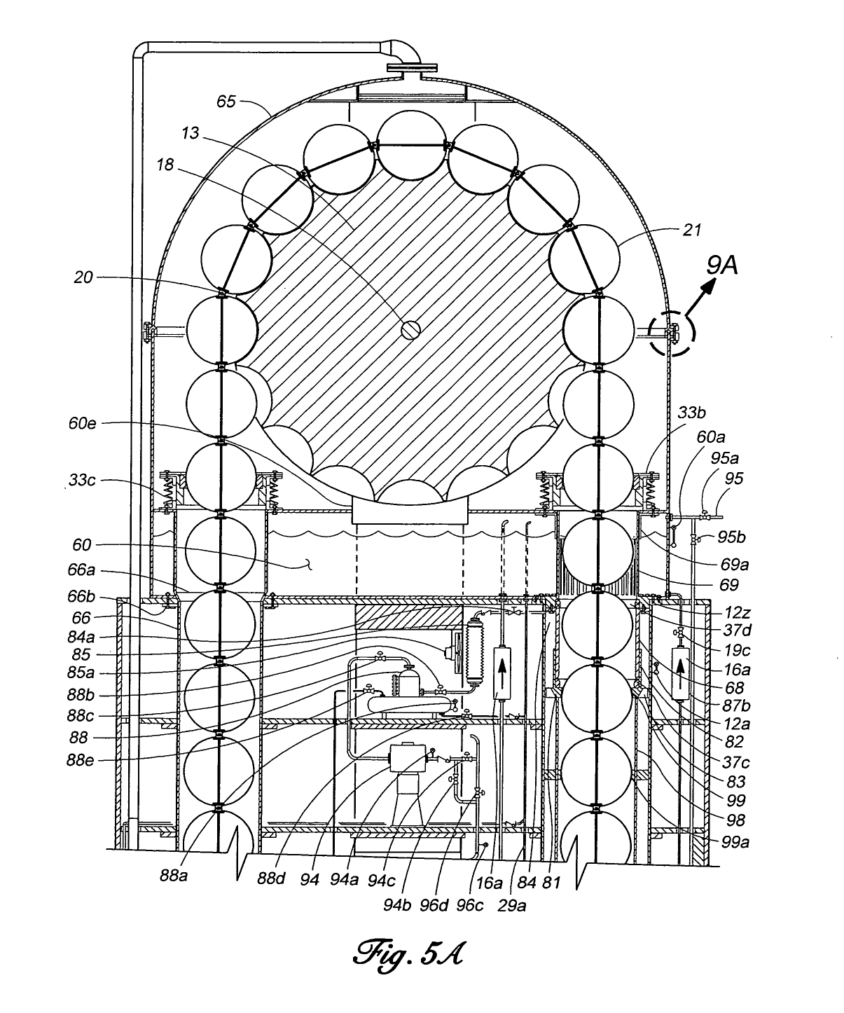

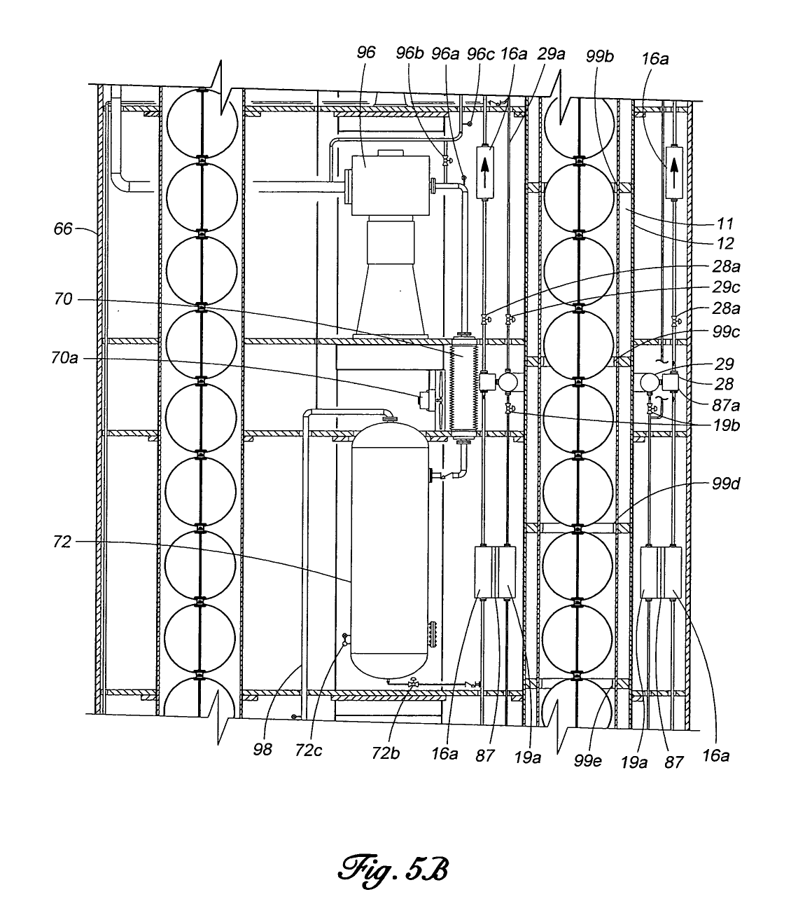

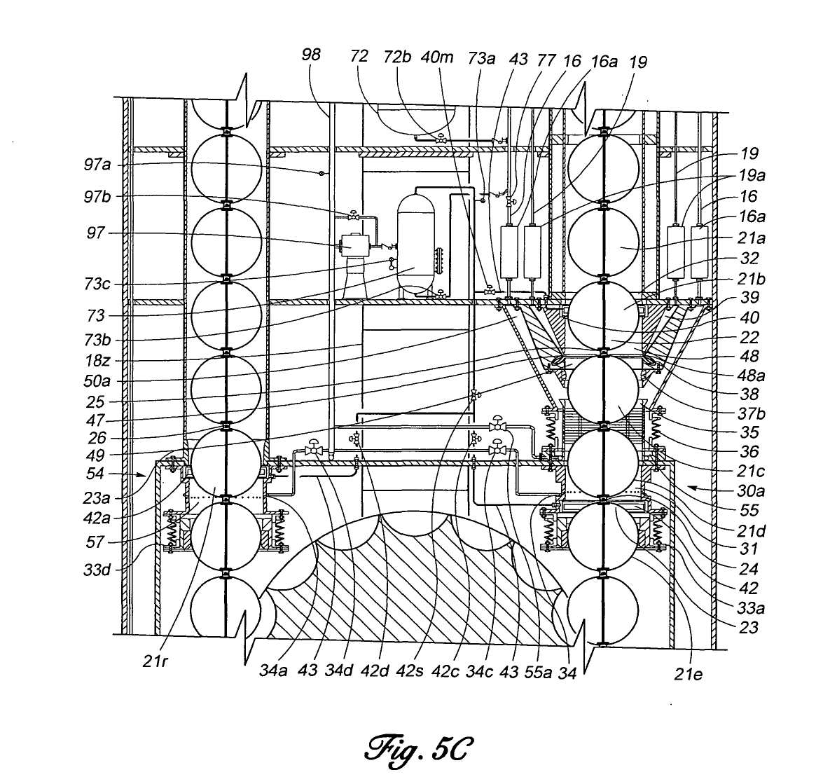

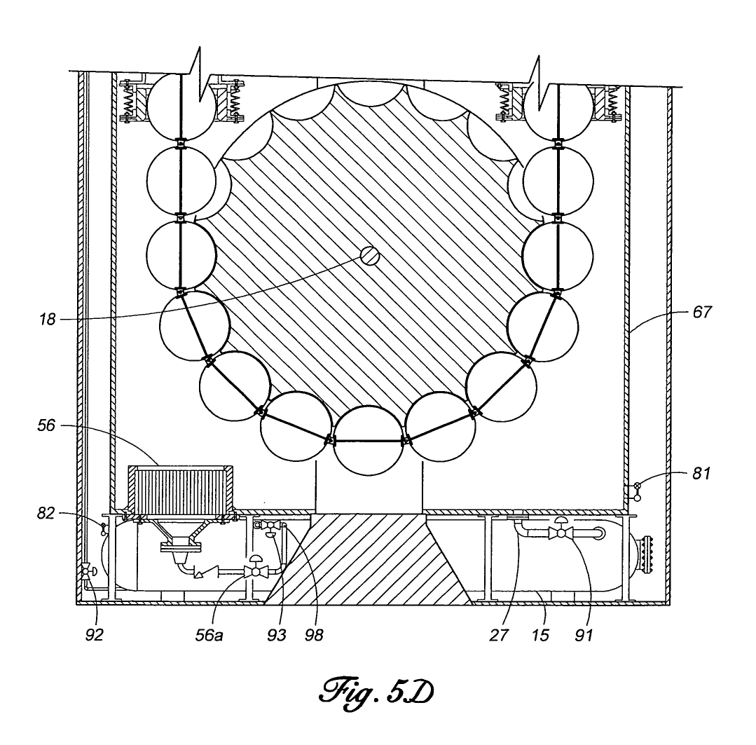

The “Closed Loop” Economy of Motion Machine, 10a of FIG. 5, allows the displacing elements 21 forming the displacement chain 20 to move up through the liquid column 11 as a function of the combined buoyancy of the immersed displacing elements. Referring to FIGS. 5A-5D, during this process the total volume of displacement of liquid in the displaced liquid containment tank 12 remains constant. The displacing elements 21 travel upward in the liquid column 11 through a series of gap clearance modulators 99a-99e. As the displacing elements 21 in the chain 20 near the top of the displaced liquid containment tank 12 each passes through an overhead liquid restriction chamber 68 and exits the displaced liquid column 11. Each displacing element then travels upward into the overhead liquid recycle tank 60 through an overhead liquid alignment sleeve 69, then exit the overhead liquid recycle tank 60 through a mechanical bellows dampener 33b. Each displacing element then enters the upper idle wheel enclosure vessel 65 where each engage the upper idle wheel 13. As the displacer elements 21 travel over the upper idle wheel 13 the displacement chain 20 is guided in a 180 arc and a change in direction of travel occurs. Simultaneously, the displacers 21 in the chain 20, disengage the upper idle wheel 13, travel vertically downward under the influence of gravity, exit the upper idle wheel enclosure vessel 65 through a mechanical bellows dampener 33c where they continue traveling vertically downward through the gravity tube 66, exit out the bottom of said gravity tube through the secondary airlock assembly 54. As the displacing elements 21 in the chain 20 exit the secondary airlock assembly 54 each enters the lower idle wheel enclosure vessel 67 through a mechanical bellows dampener 33d and engage the lower idle wheel 14. As the displacing elements 21 travel over the lower idle wheel 14 the displacement chain 20 is guided in a 180° arc and a change in direction of travel again occurs. Simultaneously, the displacers 21 in the chain 20 disengage the lower idle wheel 14 travel vertically upward, exit the lower idle wheel enclosure vessel 67 by passing through a mechanical bellows dampener 33a and enter the primary airlock assembly 30a. The displacer elements travel vertically upward through the primary airlock assembly 30a, pass through an adjustable liquid seal 40 and enter the displaced liquid column 11. As each displacing element enters the liquid column 11 the cycle is repeated. The idler wheels 13 and 14 allow the mass of the displacing elements 21 to force the displacement chain 20 down on the gravity side of the upper idler wheel as the buoyancy of the displacing elements on the displaced liquid containment tank 12 side pulls the displacement chain around the lower idler wheel 14 and up through the liquid column 11. This goes on constantly or as long as desired.

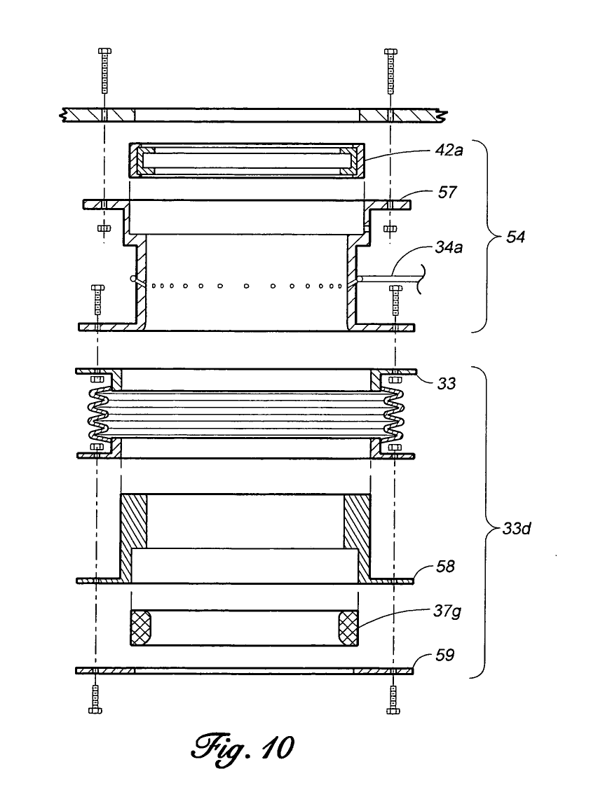

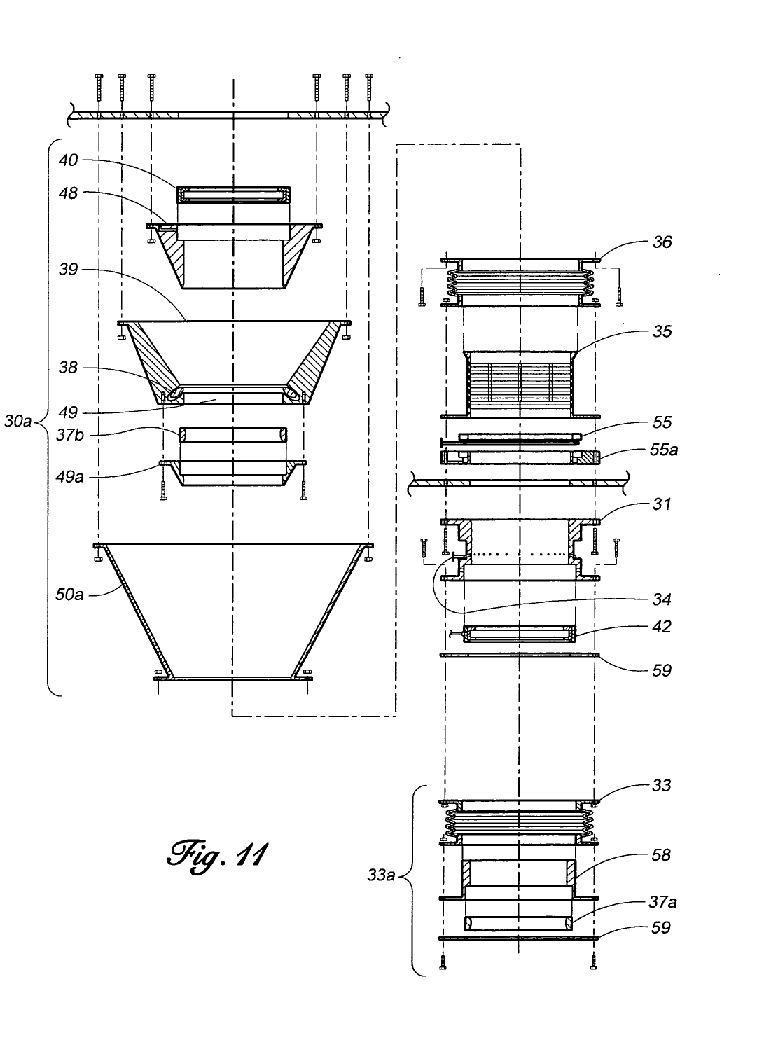

Referring to FIGS. 5, 5A-5D, 9, 9B, 10, and 11, in the preferred embodiment for managing chain 20 vibrations, mechanical bellows dampener assemblies 33a-33d serve as shock absorbers to dampen any nonlinear motion. Each assembly is comprised of a flexible bellows 33, a dampener alignment sleeve 58 and an assembly flange 59. The dampener alignment sleeve 58 is a tubular cavity with an internal alignment wear ring 37a, 37e-37g that serve to promote linear travel of the displacer elements 21 as they engage and disengage the idle wheels 13 and 14. Alignment wear rings 37a-37g are made of flexible resilient near non-friction material and serve to maintain close tolerances between displacer elements and tubular cavities.

Continuing to refer to FIGS. 5, 5A-5D, in the preferred embodiment of the primary airlock assembly 30a a series of interconnected chambers are utilized. The displacing elements enter the airlock assembly through an adjustable gas seal 42 which is configured with one or more flexible pressurized gas lines 43 for pressure actuation of the seal. The primary gas seal 42 serves to minimize liquid flow rate from the airlock cavity 31 into the lower idle wheel enclosure vessel 67. The airlock cavity 31 is configured with primary gas injection ports 34, which allow gas to be injected at variable flow rates to fine tune the differential pressure across the adjustable seal 42, in addition injected gas transfers working fluid and heat upward into the expansion sleeve 35, away from the adjustable seal 42. The expansion sleeve 35 is where the fluid density varies in response to the amount of gas present or an increase in fluid temperature. A gas diffuser ring 55 is installed around the base circumference of the expansion sleeve, with said diffuser used to inject and disperse tiny gas bubbles into the region inside the expansion bellows 36 and up into the gas diverter chamber 50a (a.k.a. air deflector), thereby additional fine tuning of the desired working fluid density is achieved by adjusting the gas to liquid ratio in this region using primary diffuser control valve 55a. Both the gas diffuser ring 55 and the expansion sleeve 35 are installed inside the expansion bellows 36, where liquid and gas flows become most turbulent due to the shape of the bellows and the mixing of liquid and gas under these conditions; in addition, the expansion bellows 36 functions as the adjustable clearance flange for completing the interlocking sequential bolt-up of the primary airlock assembly. The gas diverter chamber 50a is in the shape of an inverted cone, which deflects gas bubbles outward, thereby diverting gas introduced into the airlock assembly 30a upward and away from the gas seal 42; fluid risers 16 are connected to the top of the gas diverter chamber, such that the gas bubbles exit the airlock assembly and bypass the column of displaced liquid 11. A flexible low friction alignment wear ring 37b is located at the entrance 49a to the liquid turbulence cavity 49, which serves to scrub away any residual gas bubbles from the surface of the displacing elements 21 and serves to promote true linear travel of the chain 20 as each displacing element 21 enters the liquid turbulence cavity 49. The displacing elements 21 exiting the liquid turbulence cavity 49 travel toward the liquid seal cavity 48 through a zone of liquid turbulence as each passes through the center of the liquid turbulence promoter ring 38. The liquid turbulence promoter ring 38 is a circular beveled ring designed similar to the way an airplane wing is except that it is one continuous circular wing; the turbulence promoter ring 38 redirects any liquid traveling downward in this region into an orbital loop around the ring 38 and back upon itself, thus laminar fluid flow is beneficially disrupted and a small zone of beneficial turbulence is created. Liquid supplied from the recycle liquid down-corners 19 is routed into the Liquid Venturi Chamber 39 and through a venturi opening 47 where the liquid flow is directed towards the top of the turbulence promoter ring 38 located at the entrance to the liquid seal cavity 48. The liquid flow rate across the venturi opening 47 can be increased or decreased using the control valves 19b, thus a controlled flow of higher velocity liquid, than the liquid traveling downward through the liquid seal cavity 48 from the liquid column 11 above, is used to maintain a liquid seal barrier 48a at the entrance to the liquid seal cavity 48. The liquid seal cavity 48 is attached to the bottom of the displaced liquid containment tank 12 and an adjustable liquid seal 40 is installed at the opening 32 to the bottom of the displaced liquid containment tank 12. Liquid seal 40 serves to decrease the exposed surface area, at the top of each displacing element, by minimizing the size of the opening 32 as the displacing elements 21 exit the liquid seal cavity 48 and enter the bottom of the liquid column 11. This minimizes the force required to inject a displacing element into the bottom of the liquid column. The airlock cavity 31 and liquid seal cavity 48 are dimensioned relative to the displacing elements to minimize the amount of liquid that can be lost during airlock cycling; in addition, the piping circuits with associated control valves provide the means for controlling working fluid flow rates to assist the function of the seals for improved efficiency.

Continuing to refer to FIGS. 5, 5A-5D, in the preferred embodiment for recovering liquid from leaking seals, liquid leaking past the primary adjustable gas seal 42 is routed through the liquid drain line 27, located in the bottom of the lower idle wheel enclosure vessel 67, and recovered in one of two liquid collection tanks 15 or 15a (a.k.a. leak-water collecting reservoirs) for recycling back into the overhead liquid recycle tank 60. Level gauge 81 is configured with a high level alarm to alert an operator that liquid is accumulating in the lower idle wheel enclosure vessel 67. Automated liquid recovery is accomplished using a standard method of automated level control that senses the level changes in the liquid collection tanks using level gauges 82 and 82a respectively, such that as liquid collection tank 15 becomes full as indicated by level gauge 82 automated valve 91 closes to isolate the full tank from the liquid drain line 27; simultaneously automated valve 91a opens on the second liquid collection tank 15a placing it in service with the liquid drain line 27. An automatic drain valve 92 on tank 15 opens and a pressure valve 93 opens routing gas from gas supply line 98 to force the recovered liquid back into the overhead liquid recycle tank 60; alternatively a liquid pump 17 could be used to transfer the contents of the liquid collection tanks 15 and 15a back into the overhead liquid recycle tank 60. A Gas compressor 96 or a liquid pump 17 can be driven directly by the lower idler wheel 14 or linear escapement motor or indirectly by an electric motor by a generator driven by the upper or lower idle wheel shaft 18.

Continuing to refer to FIGS. 5, 5A-5D, in the preferred embodiment of the invention a secondary airlock assembly 54 is provided with an adjustable gas seal 42a which is configured with one or more flexible pressure lines 43 for fluid actuation of the seal 42a and an airlock cavity 57, which is configured with gas injection ports 34a that serve to control the differential pressure across the adjustable seal 42a. The secondary airlock assembly 54 provides the means to assist the primary airlock as needed by creating back pressure within the lower idle wheel enclosure vessel 67. Alternatively, the mode of airlock operation for the apparatus can be changed by disengaging the primary airlock seal 42 and engaging the secondary airlock seal 42a to allow the normally void vapor space surrounding the lower idle wheel vessel 67 to become liquid flooded; in this mode of operation the gas injection ports 34a are engaged to prevent liquid from entering the gravity tube 66. Said function for alternative mode of airlock operation is extremely useful in the event one of the adjustable seals 40 or 42 fails catastrophically. The apparatus can continue to run in this alternative mode of operation as long as the secondary seal 42a remains healthy or until proper maintenance can be scheduled to return the primary gas seal 42 and/or liquid seal 40 to normal health and peak efficiencies.

Continuing to refer to FIGS. 5, 5A-5D, in the preferred embodiment for liquid column containment, tank 12 will always contain a volume of liquid equal to or greater than the total volume of all displacers present within said liquid tank. The liquid tank is designed to operate under a slight partial vacuum by minimizing the potential mass of liquid that can travel downward within the liquid column 11 at any given point in time. A fixed structural support base 81 with associated tubular collar 82 is permanently welded in place along the internal circumference of the liquid containment tank 12 near the top of said tank. In addition, structural support base 81 is configured with vent openings 83 and an alignment wear ring 37c is installed inside the support collar 82 just above the opening 99 of the support base 81, such that as the displacing elements 21 in the chain 20 exits the liquid column 11 each travels through the support opening 99 and any residual gas bubbles entrained within the liquid column are routed through the vent openings 83 and into to the vapor recovery trap 84, located at the top of the displaced liquid containment tank 12, where the trapped gas is removed using a vacuum recovery pump 94. The overhead liquid restriction chamber 68 is mounted inside the support collar 82 and is a tubular structure dimensioned relative to the displacing elements to minimize the amount of working fluid that can pass between each displacing element 21 as each exits the liquid column 11 and enters the overhead liquid recycle tank 60. Two alignment wear rings 37c and 37d support the function of the liquid restriction chamber 68. Gap clearance modulators 99a-99e are welded in place circumferentially, at staggered intervals, inside tank 12 creating liquid filled baffled chambers with said modulators being tubular structures of minimal height and circumferentially dimensioned relative to the displacing elements, such that close tolerances are maintained as each buoyant object 21 passes through these modulators 99a-99e. Installation of the gap clearance modulators 99a-99e is such that at least one of the modulators is always engaged with at least one of the displacing elements 21 tangentially. As the chain 20 of displacing elements 21 travels upward through the liquid column 11, stiffener guides 98 provide for a smooth transition of the displacing elements 21 into the gap clearance modulators 99a-99e. The modulators 99a-99e, alignment wear rings 37c-37d and liquid restriction chamber 68 serve to maintain a slight partial vacuum within the liquid column by minimizing the potential mass of liquid that can travel downward within said liquid column 11 at any given point in time, thus improving the efficiency of the liquid seal 40. The overhead liquid recycle tank 60 provides a constant supply of liquid to the top of the liquid restriction chamber 68, thus ensuring that the displaced liquid column 11 is maintained constant. As each displacing element 21 exits the liquid restriction chamber 68 each travels upward into the overhead liquid recycle tank through an overhead liquid alignment sleeve 69 with said sleeve promoting linear travel of the displacing chain 20 at this location, while providing a means for mounting the removable components installed at the top of the liquid containment tank 60.

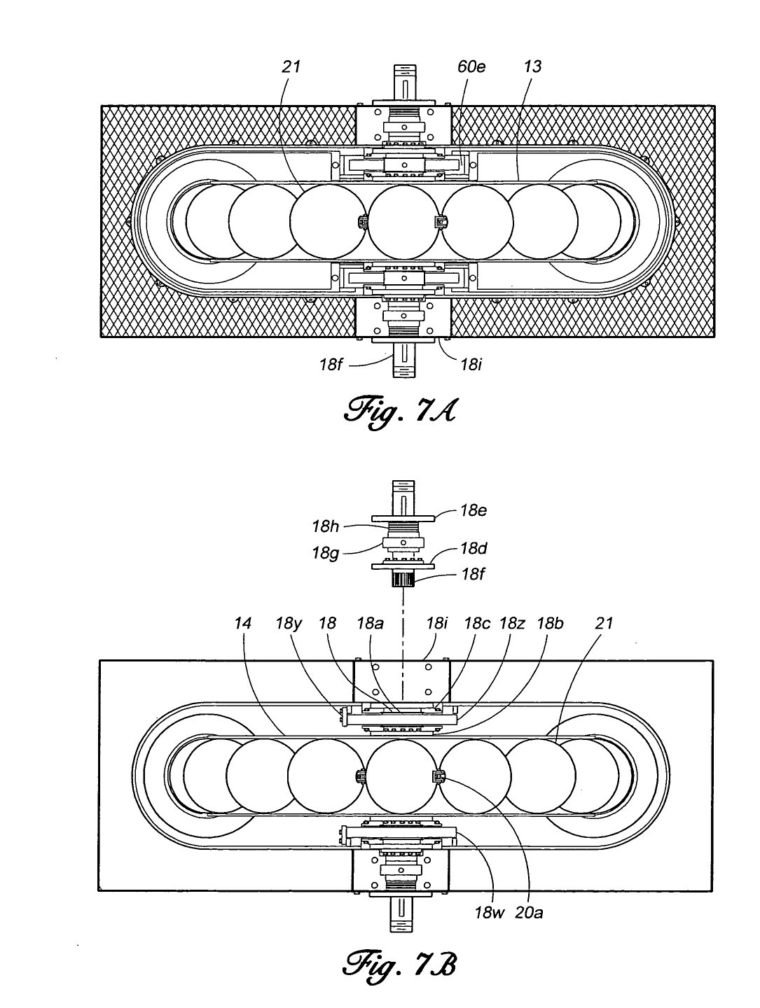

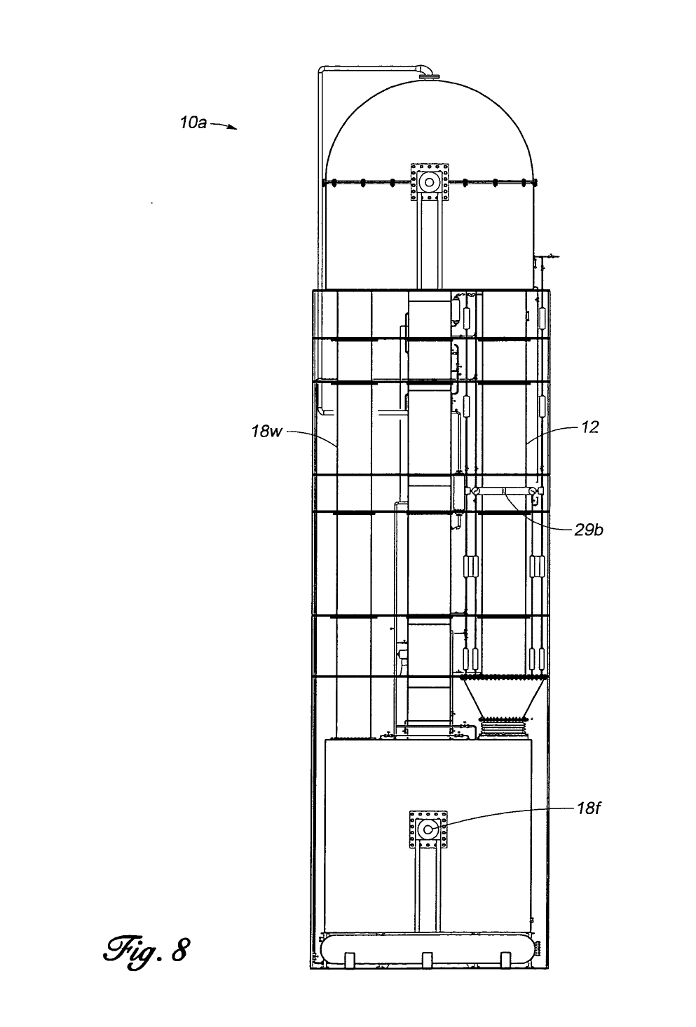

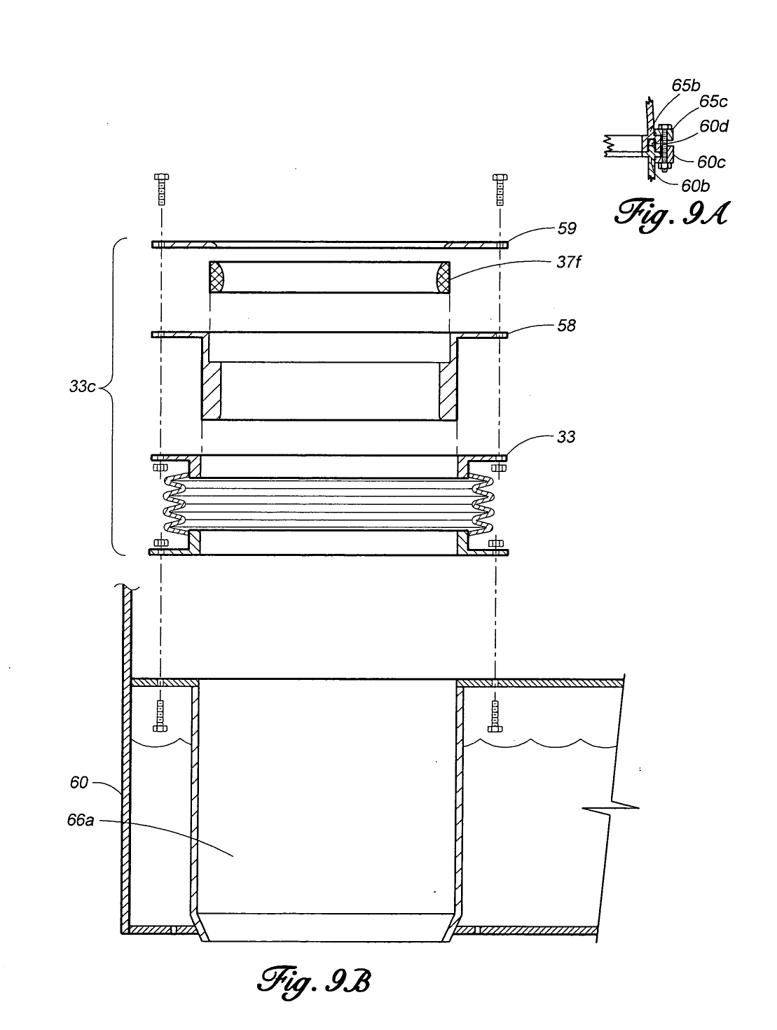

FIGS. 5A and 9B illustrate the overhead liquid recycle tank 60 installed onto the top most platform of the apparatus structure. The overhead liquid recycle tank 60 also serves as the lower portion of the upper enclosure vessel 65 in that it is of one piece construction such that the liquid recycle tank has a ceiling with walls extending above said ceiling and said ceiling serving as the floor for the upper idle wheel enclosure vessel 65. The overhead liquid recycle tank also has sleeves 60e which fit over the idle wheel support beams 18w and 18z, with said sleeves covering the beams from the floor of the overhead liquid recycle tank 60 all the way to the top of the support beams 18x (refer to FIG. 7), such that the top of the sleeves 60e are constructed to serve as bearing races on top of the top bearing groove 18x; the sleeves 60e provide a barrier (refer also to FIG. 7A) between the upper idle wheel 13 bearing races 18i and the shell of the upper idle wheel enclosure vessel 65, while also ensuring that no liquid comes in contact with the idle wheel support beams 18w and 18z. In addition, the overhead liquid recycle tank 60 has a welded in place tubular section 66a, located inside the liquid recycle tank, which is a permanent barrier between the liquid in the overhead liquid recycle tank 60 and the gravity tube 66; the tubular section 66a fits snuggly in a groove in the platform floor, which the liquid recycle tank 60 is resting on, and comes to rest on top of the gravity tube flange 66b. The gravity tube 66 is connected for air tight seal using the flange 66b which is bolted in place through the platform and into the bottom of the overhead liquid recycle tank 60. Gaskets are used at all bolt up locations to prevent fluid leaks, thus there is a gasket between the liquid recycle tank and the platform it rests on, as well as a gasket between the bottom of the platform and the gravity tube flange 66b.

In FIG. 9, installation of the removable components at the top of the liquid column is as follows: Upper mount support 69a is installed over the overhead alignment sleeve 69, wear ring 37d is inserted into the recessed opening of the overhead liquid alignment sleeve 69, next the top of the overhead liquid restriction chamber 68 is mounted to the bottom of sleeve 69 using a sealing gasket and the parts are securely attached with corrosion resistant machine bolts (alternatively seal welding can be performed at this time if so desired), next wear ring 37c is inserted inside the structural support collar 82 and the assembly comprising the chamber 68 and sleeve 69 is then inserted into the opening at the top of the liquid tank 12, such that the liquid restriction chamber is inserted circumferentially inside the support collar 82 while the lip of the overhead liquid alignment sleeve 69 is inserted circumferentially inside the top of the liquid containment tank 12. Lastly the base of the sleeve 69 is securely attached to the top flange 12z of liquid tank 12; with corrosion resistant machine bolts (alternatively seal welding can be performed at this time if so desired). Upper mount support 96a is bolted to Mechanical Bellows Dampener 33b.

FIGS. 5A and 9A illustrate how the upper idle wheel enclosure vessel 65 is attached to the overhead liquid recycle tank. The enclosure vessel 65 has an attachment ring flange 65b comprised of a female groove facing downward. The liquid recycle tank wall has an attachment ring flange 60b comprised of a male lip facing upward, with said tank 60 lip fitting inside the upper enclosure 65 ring flange 65b. A gasket material 60d is installed between the two ring flanges; the upper idle wheel enclosure vessel 65 is installed on top of the overhead liquid tank 60 wall such that the female and the male flanges compress the gasket 60d creating an air tight seal. At intervals along each ring flange welded “L” clamps 60c and 65c are installed allowing the two ring flanges to be bolted to each other for proper compression and uniform tightening of bolts to prevent gas leakage.

In FIG. 5A the preferred embodiment for the vacuum system is shown; the liquid containment tank is configured with a level sensor 12a, installed above the entrance to the liquid restriction chamber 69. If enough gas enters the liquid column the level will eventually fall below the sensor 12a, thus an alarm is configured for level 12a that will alert an operator of the need to start the vacuum pump. If so desired, level sensor 12a can be configured to automatically start the vacuum pump 94 as long as isolation valve 84a is unblocked. With the vacuum pump 94 in service, gas removed from the vapor recovery trap 84 is routed through the vapor recovery cooler 85. Vapor exiting the cooler 85 enters the vacuum drum 88 or auxiliary vacuum drum 89. The vacuum pump 94 takes suction from the top of the vacuum drums 88 and discharges the non-condensable gas through the discharge control valve 94b, thus gas is recovered to the suction of the recycle gas compressor 96. Discharge valve 94b is commanded open whenever the vacuum pump is started, while atmospheric vent valve 94c is normally closed. Both valves 94b and 94c are controlled by pressure override sensor 94a, such that if pressure in the vacuum pump discharge exceeds the desired set-point 94b will be commanded closed and 94c will be opened venting the gas stream to atmosphere. The optional vapor recovery cooler fan 85a and the auxiliary vacuum drum 89 are utilized whenever the vacuum system is in continuous service mode, which may occur whenever the apparatus 10a is operating under full load conditions and gas is entering the displaced liquid column due to a mechanical failure within the apparatus. Vacuum drums 88 and 89 are configured with level sensors 88a and 89a respectively; when one vacuum drum becomes full the other drum is automatically placed in service with the vacuum pump 94 i.e. vacuum drum 88 senses 88a high level, valves 89c, 89d and 89e on vacuum drum 89 are confirmed closed, while inlet valve 89b is commanded opened, vacuum drum 88 inlet valve 88b is closed, outlet valve 88c is closed, drain valves 88d is opened and pressurized gas valve 88e is opened thereby forcing the recovered liquid out of the vacuum drum 88 into the liquid recycle collector vent 29a piping.

In FIG. 5B the preferred embodiment for compressing gas and recovering liquid vapor is shown; recycle gas compressor 96 takes suction off the top of the upper idle wheel enclosure vessel, compresses the gas to a pressure adequate for injection into gas diffuser ring 55, gas diffuser plate 56, and airlock gas injection ports 34 and 34a. Gas from the compressor discharge is routed through gas cooler 70 before entering the recycle gas drum 72. Drum 72 supplies the bulk of the air used for air injection and liquid transfers via gas supply line 98. Compressor 96 can be operated in continuous mode or intermittently depending on the desired mode of operation for the apparatus. Whenever the compressor is operating, if the suction pressure falls below pressure sensor 96c set-point the spillback valve 96b will open routing some discharge gas back to the suction, in addition when suction pressure is high the machine will increase its load capacity for more gas throughput. If the discharge pressure sensor 96a is above set-point the spillback valve 96b will open thus discharge gas is routed back to the suction of the recycle gas compressor. In addition, when compressor 96 is operating in continuous closed loop mode, if the suction pressure becomes high-high the vent valve 96d, as shown on FIG. 5A, will open venting suction gas to atmosphere. Furthermore, when compressor 96 is operated in intermittent mode nothing is vented to atmosphere, since suction pressure sensor 96c will start the compressor when suction pressure is high-high and stop the compressor when suction pressure is low-low. Recycle gas drum 72 utilizes level sensor 72c to control the liquid drain valve 72b. Any liquid recovered in the gas drums is routed back into the overhead liquid recycle tank 60 via the fluid risers 16 or alternatively could be routed into the recycle collection vent 29a piping.

In FIG. 5C the preferred embodiment for supplying pressurized gas to the adjustable seals is shown; seal gas compressor 97 takes suction from the recycle gas header exiting the recycle gas drum 72 and compresses it to a pressure adequate for seal operation then routes the high pressure gas into the seal gas drum 73. Compressor 97 is an intermittent compressor controlled by pressure sensor 73a, which opens spillback valve 97b when target pressure is achieved in order to maintain the desired seal gas drum pressure. The seal gas pressure sensor 73a stops the compressor when seal gas pressure is high-high or when spillback valve output is greater than 50 percent open and starts the compressor when seal gas pressure is low-low. Gas supply line 98 is configured with a suction pressure sensor 97a which is provided for protection of the compressor 97 and will shutdown the compressor in the event the suction pressure goes low-low. Seal gas drum 73 utilizes level sensor 73c to control the liquid drain valve 72b. Any liquid recovered in the gas drums is routed back into the overhead liquid recycle tank 60 via the fluid risers 16 or alternatively could be routed into the recycle collection vent 29a piping. Isolation valve 77 is a normally open valve when mode of operation includes gas injection into airlock gas injection ports 34 and 34a, but when mode of operation is such that no air injection is being used or when low rate of air is in use, valve 77 should be closed to facilitate transferring liquids from the drain valves 72b and 73b back into the overhead fluid recycle system.

In a preferred embodiment for recycling fluid within the airlock assembly 30a, gas injected into the airlock cavity 31 and/or the gas diffuser ring 55 provides a motive driving force of rising gas bubbles that serves to transport some entrained liquid and heat upward to the top of the gas diverter chamber 50a where external fluid risers 16 are provided to receive the rising gas bubbles, route said bubbles around the liquid containment tank 12 and exhaust the fluid stream into the top of the overhead liquid recycle tank 60; in addition, each fluid riser 16 is connected to at least one backflow inhibiter conduit 16a, one liquid separation conduit 28 and is provided with at least one fluid control valve 28a. External heat exchanger fins allow rising fluid to exchange heat with both the atmosphere and the liquid flowing downward in the down-comer backflow inhibiter conduit 19a. The liquid separation conduit 28 also utilizes external heat exchanger fins to exchange fluid heat with the surrounding atmosphere, while the internals direct any condensing liquid to the liquid recycle accumulator 29.

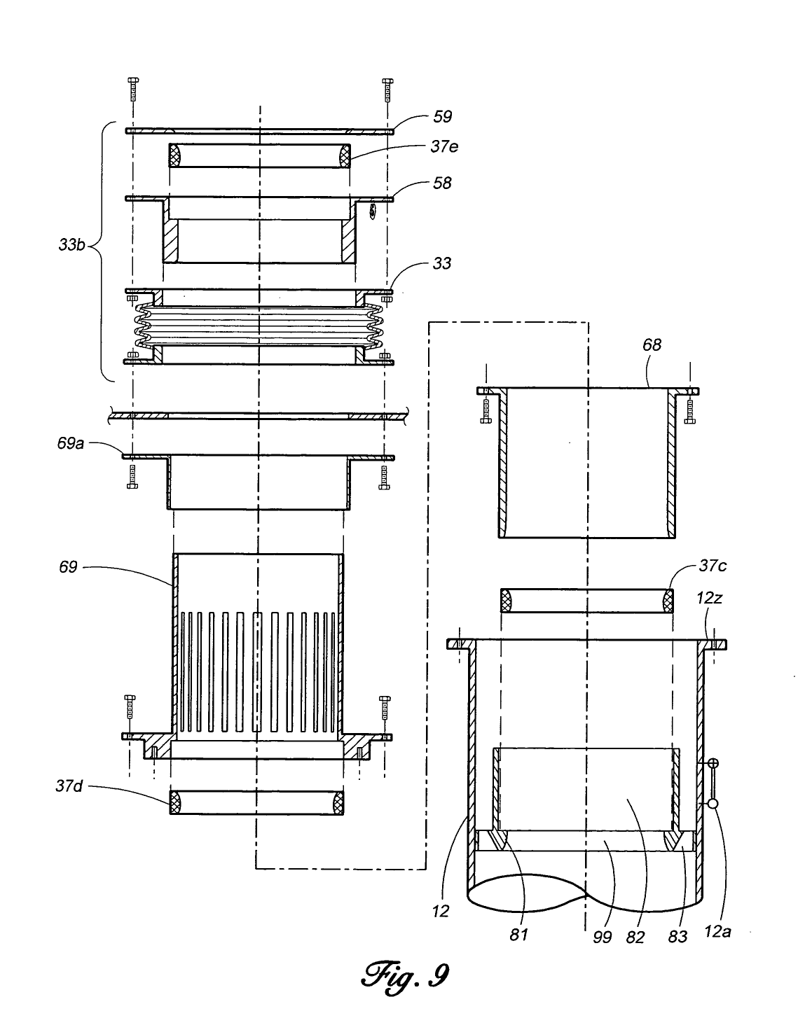

In the preferred embodiment for supplying liquid to the liquid venturi chamber 39, the liquid recycle accumulator 29 receives the recovered liquid from the liquid separation conduit 28 and redirects it into the liquid down-corners 19. The liquid recycle accumulator has a vent line 29a for venting gas from the liquid accumulator; normally closed vent valve 29c is controlled by level sensor 29b, as shown in FIG. 8, such that when low level in the liquid recycle accumulator 29 is sensed, the vent valve is opened. Each down-corner 19 is connected to the bottom of the liquid recycle accumulator 29, connected to at least one backflow inhibiter conduit 19a, connected to the top of the liquid venturi chamber 39 and is provided with at least one liquid control valve 19b. In addition, at least one of the down-corner piping circuits 19 is connected to the overhead liquid recycle tank 60 with a liquid control valve 19c provided to ensure a steady supply of liquid can always be supplied to the Liquid venturi chamber 39. Furthermore, external heat exchanger fins allow backflow inhibiter conduit 19a to exchange heat with both the atmosphere and the fluid risers backflow inhibiter conduit 16a.

In the most efficient embodiment for back flow prevention, the use of a valvular conduit design 16a, 19a provides for minimal differential pressure drop through the piping circuits, while providing for efficient response to variable fluid flow control adjustments.

Referring to FIGS. 5, 5A-5D, two fluid risers 16 and two liquid down-combers 19 are shown; depending on the size of the apparatus to be installed, the number of risers and down-corners may be increased or decreased and/or the piping size may be varied to provide adequate fluid flow away from the gas diverter chamber 50a and liquid flow to the liquid venturi chamber 39.

In one alternative embodiment for backflow prevention within the fluid risers 16 and down-corners 19, any of the various commercially available check valves such as swing check or stop check etc. may be utilized to provide backflow prevention within this piping circuit.

In one alternative embodiment for exchanging heat within the fluid riser 16 and down-corners 19, any commercially available heat exchanger such as cooling water exchangers, forced air flow exchangers, tube and bundle exchangers etc. may be utilized for exchanging heat within the piping circuits.

The mass of the liquid lost by a single cycle of the airlock chamber is minimized by the efficiency of the liquid seal 40 and the airlock assembly gas seal 42. In a preferred embodiment, the buoyant force, w_{B}, created by a displacing element is significantly greater than the forces, w_{U} and w_{L}, required to turn the upper and lower idler wheels, the force, w_{P}, required to pump out or pressure out and lift the mass of liquid lost during a cycle to the top of the liquid recycle tank 60, the force, wᵢ, require to inject gas into the system when creating variable density and differential pressure zones as well as for conducting fluid heat transfers and transferring fluid upward through fluid risers 16 back to the top of the overhead liquid recycle tank 60 and the force, w_{S}, required to regulate the seal pressure and pass the displacing element 21 into the liquid column 11, i.e., w_{B} is greater than w_{U}+w_{L}+w_{P}+wᵢ+w_{S}. The surplus force, w_{T}=w_{B}−(w_{U}+w_{P}+wᵢ+w_{S}), is the amount of useful work the system can perform. Thus wᵣ is a function of the density relative to the immersing liquid and size of a displacing element minus the various system losses.

The surplus force, w_{T}, may be extracted from the system via a mechanical coupling to either/or both drive shafts 18 which are extensions of the axles for the upper and lower idler wheels 13 and 14. The mechanical coupling may drive any form of mechanical device capable of operating from a rotary input or it may be an electric generator or alternator.

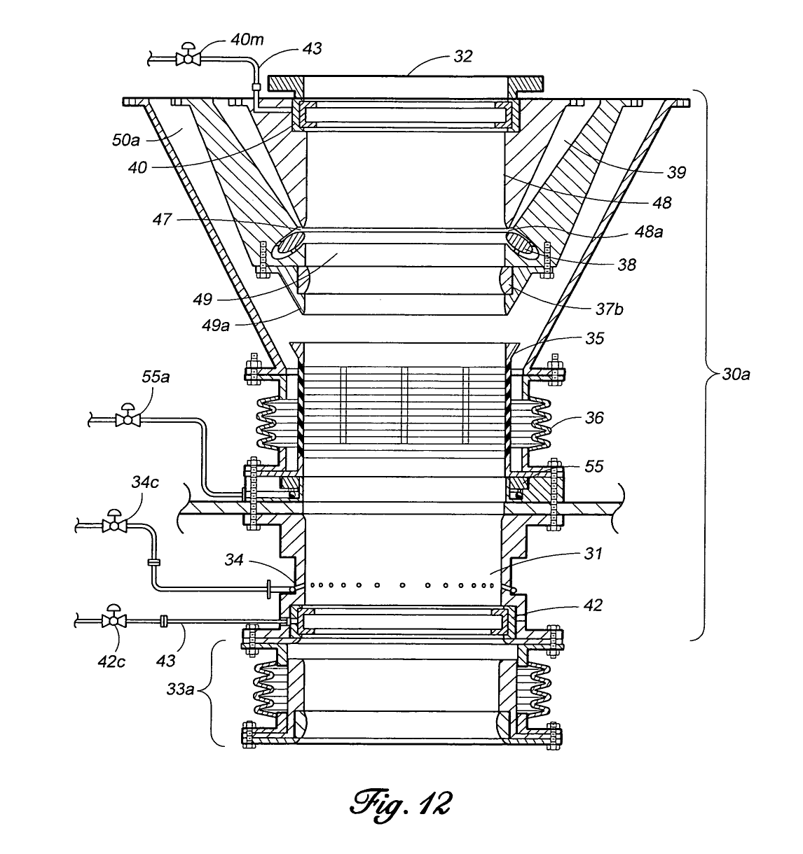

When comparing FIG. 4 from U.S. Pat. No. 7,434,396 with FIG. 5C and FIG. 12 of the preferred embodiment of the invention for gas deflection, one can see that the original air deflector 50 is now located within the internals of the primary airlock assembly as the gas diverter chamber 50a, thus gas deflection is able to be performed outside the column of displaced liquid, which is a more desirable location for gas deflection. It has been demonstrated in “Bermuda Triangle” related experiments that a curtain of bubbles can significantly reduce the buoyancy of a floating object and that a mass of methane gas bubbles have been shown to cancel the buoyancy of a ship at sea and cause it to sink. This phenomenon is useful for injecting a buoyant object into a displaced column of liquid, thus a key benefit of injecting gas into the primary airlock assembly is that the density of the fluid, within the airlock assembly, can be beneficially reduced to aid in injecting the displacing elements into the column of liquid, but the majority of the gas bubbles must not be allowed to enter the displaced column of liquid 11 along with the chain 20 of displacing elements 21. If allowed to enter the liquid containment tank 12 gas bubbles would decrease the chain's buoyancy; therefore, the gas diverter chamber 50a is designed to be within the primary airlock assembly 30a, thus ensuring that any gas bubbles accompanying the displacer chain are forced away from the chain by the inverted cone shape of the gas diverter chamber 50a and the alignment wear ring 37b, which serves to scrape away any residual gas bubbles from the body of the displacing elements before they enter the displaced column of liquid 11. This eliminates any negating effect that gas injection could have on the buoyancy of the chain of displacing elements.

When comparing FIG. 1 and FIG. 2 from U.S. Pat. No. 7,434,396 with FIG. 5 and FIG. 5C of the preferred embodiment, a gas stream can be injected at multiple locations depending on the mode of operation employed i.e. into the airlock cavities 31 and 57 through gas injection ports 34 and 34a, into the expansion bellows 36 through a gas diffuser ring 55 or into the bottom of the lower idle wheel enclosure vessel 67 through a gas diffuser plate 56 using control valve 56a. In the preferred mode of operation gas is injected into the apparatus at two of the available aforementioned locations, depending on the desired mode of operation, as a result liquid leakage past the gas seal 42 is reduced, thereby significantly reducing wp in the work force equation. In addition the force, w_{S}, required to regulate the seal pressure and pass the displacing element 21 into the liquid column 11 through liquid seal 40 is reduced due to a fluid density change within the airlock assembly 30a and the beneficial impact of gas injection on the differential pressures across the system. Therefore, wᵢ is a variable integral in the work force equation such that as wᵢ increases w_{P} decreases proportionally, while w_{S} decreases along a nonlinear curve until wᵢ exceeds the threshold flow rate; said threshold being the point at which the gas flow rate within the airlock assembly 30a significantly exceeds liquid flow rate within the airlock, such that excessive quantities of gas are being introduced into the liquid column 11. As long as gas is injected in a controlled manner and at desired flow rates the system's ability to perform useful work wₜ is positively impacted.

In the most efficient embodiment, liquid lost by airlock cycling is not recycled within the apparatus 10a. It is allowed to flow away from the system to be used for whatever purpose is most beneficial. Replacement liquid is supplied to the overhead liquid recycle tank 60 by gravity feed from any available source located at an elevation higher than tank 60. This external source of liquid enters the apparatus 10a through the liquid makeup piping 95. Examples of such liquid sources are: elevated rainwater collecting cisterns, lakes, ponds, rivers, streams, etc. Using naturally occurring water sources to replenish a displaced water column 11 eliminates w_{P} and wᵢ from the work force equation and thus maximizes the system's ability to perform useful work w_{T}.

In a typical reduction to practice, the invention uses displacing elements 21, each of which displace 1247.578 gallons of water plus the volume of the material forming the displacer and therefore each provide a buoyant force w_{B} equal to the weight of the displaced water minus the weight of the displacer, assuming the liquid forming the column is water. The weight of the displacing elements 21 does not have to be considered further because, as can be seen in FIGS. 5, 5A-5D, the number of displacing elements of chain 20 on one side of the upper idler wheel 13 equals the number on the other side. Thus the total weight of the displacers being pulled down by gravity on one side equals the weight of the displacers on the other and the system is in balance, leaving only the buoyant force as calculated according to Archimedes' principle. In the exemplary system, the water column is high enough to immerse fourteen oblate spheroid shaped displacing elements 21 of the chain 20 to provide a force w_{B} of 129,748 pounds, assuming the water being used in column 11 weighs 8 pounds per gallon.

When a displacer 21 enters the water column 11, it displaces a volume of water equal to the displacer's total volume, i.e., the volume inside the displacer plus the volume of the material forming the displacer. The mass (weight) of the displacer divided by the mass (weight) of the displaced water equals the specific gravity (sp. gr.) of the displacer. The displacer's buoyancy in water is a function of the displacer's specific gravity. When this value is less than 1, the specific gravity of water, the displacer is positively buoyant. More simply, the buoyant force exerted by a displacer is equal to the weight of the displaced water minus the weight of the displacer. Assuming the oblate spheroid shaped displacer is made of ¼″ rolled 304 stainless steel with a density of 0.286 lbs/in³, having a width or outside diameter of 7 ft and a height of 6.5 ft, then the displacer has a total volume of 166.7662 ft³, which is subtracted from the internal void volume 163.7305 ft³ (i.e., inside diameter is 6.95833 ft) to get the volume of metal of the displacer 437.15 in³, thus the displacer alone weighs 125 pounds, while the linkage and connection bolts for each displacer weigh 45 pounds for a total displacer weight of 170 pounds. Therefore the exemplary displacer 21 displaces 1,247.578 gallons of water which, at 8 pounds per gallon, weighs 9980.624 pounds and has a Sp. gr. of 0.012527. According to Archimedes' principle, the buoyant force exerted by water is equal to the mass of the displaced water minus the mass of the displacer. In the exemplary case, the buoyant force of a single displacer is the 9,980.624 pounds of water displaced minus the 170 pound displacer for a buoyant force of 9,810.624 pounds. The water column in the example holds thirteen displacers of the displacer chain to generate a total displacement force of 127,538 pounds. The foregoing assumes a constant temperature of 4° C., a temperature at which the specific gravity of water is unity.

In a preferred embodiment representing the best mode of practicing the invention, the average specific gravity of all of the elements and voids comprising a liquid displacer is less than unity. Thus the specific gravity of each liquid displacer is less than the specific gravity of the liquid in the column when the liquid is water. The liquid may be other than water, the only controlling criteria is that the specific gravity of each liquid displacer is less than the specific gravity of the liquid, i.e., the gross density of each liquid displacer is less than the density of the liquid of the column.

The means by which the chain of displacers 20 enter the liquid column is illustrated by FIG. 5C which depicts displacers passing through the airlock assembly 30a. In the best reduction to practice, the airlock is a tubular structure 31 sealed around an opening 32 in the bottom of the displaced liquid containment tank 12. Three seals, 40, 42 and 42a, effect the airlock function in this embodiment by sequentially opening and closing as the displacers of the chain 20 move up into the liquid column 11. The airlock sequence starts with liquid seal 40 forming a liquid tight barrier around the circumference of displacer 21b as it approaches tangentially, while seal 42 which was tightly pressing around the coupling link 24 forming the chain link connection joining displacer 21d to displacer 21e opens about the upper end 23 of displacer 21e and seal 42a forms an air tight barrier about the circumference of displacer 21r as it approaches tangentially. As the displacer chain moves up, displacer 21b travels past tangent to seal 40 which then closes about the base end 22 of displacer 21b until tightly pressed about coupling link 25, meanwhile seal 42 opens about displacer 21e. As the displacer chain moves down across seal 42a, displacer 21r travels past tangent to seal 42a which then closes about the upper end 23a of displacer 21r until tightly pressed about coupling link 26. As the movement of the chain continues, seal 40 slips off displacer 21b and closes about coupling link 25 then engages displacer 21c, completing the cycle admitting one displacing element 21 into the bottom of the liquid column. As the chain 20 travels through the airlocks 30a and 54 the gas seals 42 and 42a remain in contact about the surface areas of each displacing element 21 as each passes through the center of the seals. As the chain exits the primary airlock assembly 30a, liquid seal 40 remains in contact about the surface area of each displacing element 21 as each passes through the center of the seal and enters the liquid column, preventing liquid leakage. During this process, the level of liquid in the displaced liquid containment tank 12 remains constant because as one displacer enters through the airlock, one displacer exits at the top of the liquid column and no energy is lost as the displacing elements 21 enter the bottom of the liquid column, i.e., the total displacement of liquid in the tank remains constant.

As claimed in parent U.S. Pat. No. 7,434,396, in one embodiment of the airlock seals 42, 42a and liquid seal 40 are pressure actuated, see FIGS. 3A, 5C, 10 and 12. Each seal has one or more pressure supply lines 43 capable of supplying compressed gas to the main body of the seal. The main seal body is comprised of a ridged ring 44 surrounding an expandable circular member 45 which forms an opening 46 through which a displacer 21 may pass. The circular member 45 is inflated by pressurized fluid supplied via the gas line 43 which, because of the ridged ring, expands only toward the center. The expandable circular member 45 is capable of expanding under the influence of pressurized fluid to completely close opening 46 to form a fluid tight seal around a displacing element or coupling link. The flexible circular member may be inflated sufficiently to cause it to close about the coupling links and maintained to also seal about the displacers. This mode of operation requires no further action once the seal is initially inflated i.e. gas control valves 42c, 42d can be placed in the manual open position and seal gas control valve 42s can be closed, thus allowing the gas seals 42 and 42a to supply each other with gas volume such that when a displacing element is approaching tangent to a seal the deflating seal forces its gas volume into the seal that is inflating between displacers. Seal gas control valve 40m can be placed in the manual opened position to allow the liquid seal 40 to float on the volume of seal gas in the supply drum 73. Alternatively, in a preferred method of operation, air pressure in the expandable circular member 45 is varied by using proximity sensors and automating seal gas control valves 42c, 42d and 40m to provide a water tight seal about the various diameters passing there through while offering the least amount of resistance to the displacer chain movement. In addition, a liquid fluid may be used to inflate seals 40, 42 and 42a. Furthermore, an alternative liquid differential seal 40a is herein presented as an alternative for liquid seal 40.

FIG. 3B illustrates an alternative embodiment for a liquid seal 40a which can be used in place of or in addition to the inflatable liquid seal 40. In this embodiment of the liquid seal a novel approach is presented for sealing the gap between interconnected solid bodies and a fluid when said bodies are moving in a direction of linear travel using differential pressures existing across the seal opening. More specifically as this liquid seal 40a is applied to the present invention, whereby a buoyant object is traveling upward through a displaced liquid column 11 through a normally fixed opening 32 with a differential pressure existing across said opening such that pressure is greatest on the liquid column side of the opening. In one embodiment “fluid differential seal” 40a is a self actuating floating iris seal, which is configured to actuate above the opening 32 of tank 12 with said self actuation being a function of float buoyancy and differential pressures across the seal opening; when utilizing this seal the liquid containment tank will have an increased width and height that provide additional liquid volume to both account for the additional volumetric requirement of the buoyant float ring 40b and the added length requirement of the seal sleeve body 40c. As each displacing element 21 travels upward through tank opening 32 the differential pressure across said opening is such that pressure is always greatest on the liquid column side. Fluid differential seal 40a is comprised of a float ring 40b, a seal sleeve body 40c, a seal sleeve anchor base 40d, a float ring to seal sleeve connection plate 40e, a seal sleeve to float ring connection plate 40f, a means of connecting 40g the components together, float ring guides 40h, spiral guides 40i, float ring stop 40s and spiral guide retaining sleeve 40r. The float ring has a tubular opening 40j in its center allowing for free travel of a displacing element 21 and slots 40k are provided to permit fluid to pass freely around the float ring 40b and around the outside of the seal sleeve body 40c. The seal sleeve 40c is made of a low to near non-friction durable and flexible seamless tubular material such that it provides minimal resistance to a body sliding within the sleeve and can withstand continuous twisting cycles from 0° to 180°. The top portion of sealing sleeve 40c is permanently attached to the seal sleeve to float ring connection plate 40f, which is bolted to the float ring to seal sleeve connection plate 40e using connectors 40g. The bottom portion of sealing sleeve 40c is permanently attached to the anchor base 40d. The height of the liquid column 11 and the density of the liquid column determine the pressure of the liquid at the bottom of tank 12 with said tank bottom liquid pressure normally greater than that which exists below the tank opening 32. Float ring 40b utilizes float ring guides 40h which travel between spiral guides 40i; spiral guide retaining sleeve 40r is a tubular cavity that is attached to the internal circumference of tank 12 above the opening 32. Due to the buoyancy of float 40b a lift force is always applied to the top of sealing sleeve 40c, while simultaneously the spiral guides 40i ensure that the float ring 40b rotates as it travels. The seal sleeve anchor base 40d is installed inside the bottom of tank 12 at the entrance to the opening 32 and is firmly bolted in place.

FIG. 3B, FIG. 3C, and FIG. 3D illustrate one embodiment of the liquid differential seal wherein the spiral guides 40i ensure that the float ring 40b is made to rotate from 0° toward the 180° position as it travels downward. With this orientation the seal interaction is as follows: When displacer 21b is at tangent of the tank opening 32 the float ring 40b extends upward toward its full travel, thus the seal sleeve aperture 40p is opening as liquid pressure inside and outside the seal sleeve body equalizes. The moment displacer 21b travels past tangent of the tank opening 32 the lower portion of the seal sleeve 40c moves toward the tank opening 32 and the seal sleeve body 40c engages the lower portion of displacer 21a as the float ring travels in a downward path due to the outside portion of the seal sleeve just below the tangent of the displacer 21b experiencing a greater hydraulic force pushing downward and inward toward the bottom of the liquid tank; whenever an open gap is present at the tank opening 32 the seal sleeve experiences a greater thrust force downward than the float ring can compensate for, thereby forcing the float ring 40b to spiral downward forming the aperture 40p below the tangent line of the displacer 21a and closing the aperture 40p about the top of displacer 21b thus forming a liquid tight barrier about displacer 21b, which in turn increases the differential across the seal sleeve body 40c. In addition, as the chain of displacers continues to travel upward and the aperture closes about displacer 21b the aperture tangent 40t changes vertical position as the displacer 21b moves past tangent of the aperture, in this manner the aperture tangent moves quickly downward along the base of the displacer 21b and about the linkage connection; this downward vertical position change of the aperture tangent 40t in effect squeezes the displacer 21b up and away from the collapsing aperture, since the buoyant surface area at the bottom of the displacers 21a and 21b are more quickly exposed to the liquid column. As the aperture closes about the linkage connection between displacers 21b and 21c the next displacer 21c enters the iris seal tangent to the tank opening 32, which decreases the differential pressure across the seal sleeve body 40c by allowing a small amount of liquid to pass into the aperture opening thus equalizing the hydraulics across the seal sleeve wall; as this happens the float ring is again able to quickly lift the seal sleeve away from the opening 32 which in turn opens the aperture 40p as the float ring quickly spirals upward toward full travel. The seal cycle is repeated as each displacer exits the liquid seal cavity 48 and enters the seal sleeve to travel past tangent to the opening 32. This goes on as long as desired or until the floating iris seal requires maintenance to return it to peak efficiency.

Alternatively, utilizing a slight variation of the aforementioned embodiment for the liquid differential seal, the spiral guides 40i can be utilized to ensure that the float ring 40b is made to rotate from 0° toward the 180° position as it travels upward, this is accomplished simply by rotating the float ring 40b to the 180° position in the opposite direction as the spiral guides 40i. With this orientation the seal interaction is as follows: When displacer 21b is at tangent of the tank opening 32 the float ring is extending toward its full upward travel, thus the seal sleeve aperture 40p is closed about the linkage between displacers 21a and 21b forming a liquid tight barrier; as displacer 21b travels further up into the seal sleeve and passes tangent to the opening 32 the upper surface of displacer 21b engages the iris aperture 40p. Since liquid pressure increases with depth the outside of the seal sleeve below the aperture 40p experiences a greater hydraulic force pushing down and inward on the lower portion of the seal sleeve below tangent of displacer 21b tangent, thus a greater force is exerted toward the liquid tank opening 32, but at a location on the outside of the seal sleeve 40c below aperture 40p; as a result the seal sleeve experiences a greater thrust force downward than the float ring can compensate for and the net effect is that the float ring 40b quickly spirals downward, the aperture tangent 40t moves upward while the aperture 40p opens; as the sleeve wall is collapsing below tangent to 21b this forces the displacer 21b to move upward and away from the collapsing seal sleeve. When displacer 21c enters tangent to the tank opening 32 the differential pressure across the seal will decrease, while at the same time the aperture will be fully open about displacer 21b and a small amount of liquid will pass the aperture equalizing the hydraulics across the seal sleeve. When this occurs the float ring is again able to lift the seal sleeve, which in turn closes the aperture 40p about the base of 21b forming a liquid tight barrier, thus the seal cycle is repeated. This goes on as long as desired or until the floating iris seal requires maintenance to return it to peak efficiency.

FIGS. 3B-3D illustrate how the aforementioned embodiment of the iris seal 40a utilizes the differential pressure that exists across the bottom opening 32 of tank 12, thus the hydraulic force that would normally be a negative factor in the work force equation is now able to be utilized to improve liquid seal efficiency. The airlock assembly 30a may still be employed when utilizing the floating iris seal 40a, w_{P} and wᵢ are effectively reduced in the work force equation and the system's ability to perform useful work w_{T} is positively impacted. In addition, iris seal 40a can be configured with a spring actuated ring instead of a float ring 40b such that the seal could function in applications where the object is traveling on a horizontal plane and a buoyant float ring would therefore not be as advantageous. Furthermore, seal sleeve body 40c can be fabricated having a uniform diameter with equal entry and exit openings; alternatively, the seal sleeve can be fabricated to have a larger entry or exit opening, thus the aperture position can be fine tuned for quicker iris opening and closing action.

FIG. 3E illustrates an alternative embodiment for liquid iris seal, whereby liquid differential seal 40z is an adjustable tension floating iris seal comprised of a float ring 40b, a seal sleeve body 40c, a lower adjustable anchor base 40v, a float ring to seal sleeve connection plate 40e, a seal sleeve to float ring connection plate 40f, means of connecting 40g the components together, float ring guides 40h, tubular guide sleeve 40w, and linear guides 40x. The float ring has a tubular opening 40j in its center allowing for free travel of a displacing element 21 and slots 40k are provided to permit fluid to pass freely around the outside of the seal sleeve body. The seal sleeve 40c is made of a low to near non-friction durable and flexible seamless tubular material such that it can withstand continuous twisting cycles from 0° to 180°. The top portion of the seal sleeve 40c is attached to the seal sleeve connection plate 40f. The bottom portion of seal sleeve 40c is attached to the adjustable anchor base 40v, which utilizes water bearings 40u. Float ring 40b utilizes guides 40h which travel between linear guides 40x. Due to the buoyancy of float 40b a lift force is always applied to the top of sealing sleeve 40c, while the linear guides 40x ensures that the float ring 40b travels up and down in a linear vertical path. The adjustable anchor base 40v is mounted at the entrance to the opening 32 and has a variable resistance actuator with a pneumatic torque tension cylinder, which is supplied pressurized gas using a control valve, such that as gas pressure is increased the base 40v is rotated from 0° to 180°, thus the float ring 40b moves downward in the liquid column and the iris aperture 40p forms about the connecting linkage at the base of displacer 21a. As displacer 21b travels further up into the displaced liquid column 11 the upper surface of displacer 21b engages the iris aperture 40p forming a liquid tight barrier around the displacer 21b. Since liquid pressure increases with depth the outside of the seal sleeve below the aperture 40p experiences a greater hydraulic force pushing down and inward on the lower portion of the seal sleeve below the aperture 40p, thus a greater force is exerted toward the liquid tank opening 32, but at a location on the outside of the sleeve below aperture 40p; as a result the seal sleeve experiences a greater thrust force downward than the resistance within the variable resistance actuator and the net effect is that the base will rotate toward 0° and the float ring 40b travels upward, while at the same time the aperture tangent 40t moves upward as the aperture opens; the displacer moves upward and away from the collapsing seal sleeve below the aperture 40p. When the displacer travels upward to a location tangent to the aperture the aperture will be fully open and the liquid tight barrier is temporarily lost as a small amount of liquid passes the aperture equalizing the hydraulics across the seal sleeve. When this occurs the variable resistance actuator is again able to lower the float ring 40b, which in turn closes the aperture 40p thus the seal cycle is repeated. This goes on as long as desired or until the floating iris seal requires maintenance to return it to peak efficiency. Alternatively iris seal 40z can be configured with a spring actuated ring instead of a float ring 40b such that the seal could function in applications where the object is traveling on a horizontal plane and a buoyant float ring would therefore not be as advantageous. In addition, in place of the automated pneumatic torque tension cylinder a mechanical spring actuated torque tensioner could be utilized. Furthermore, the variable resistance actuator and pneumatic torque tension cylinder can be replaced with position indicators and synchronous pneumatic control valve actuation of the adjustable base 40v. Variable resistance actuator and pneumatic torque tension cylinder are standard pieces of equipment commercially available.

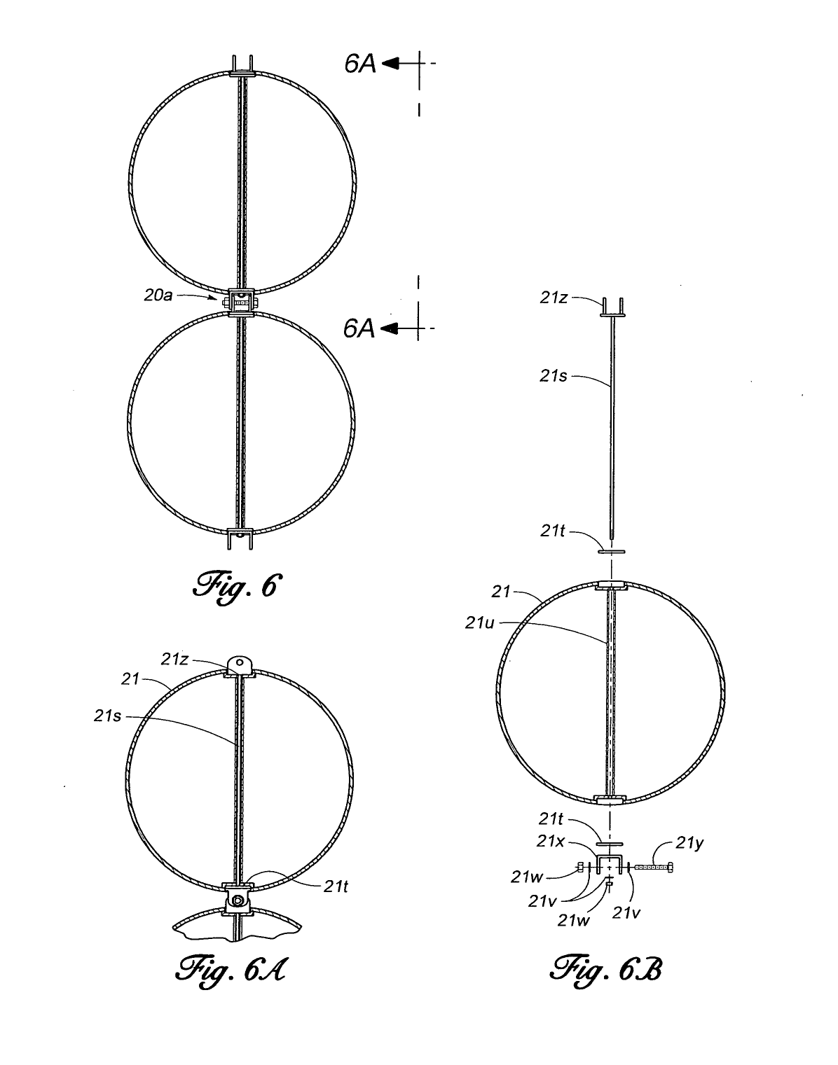

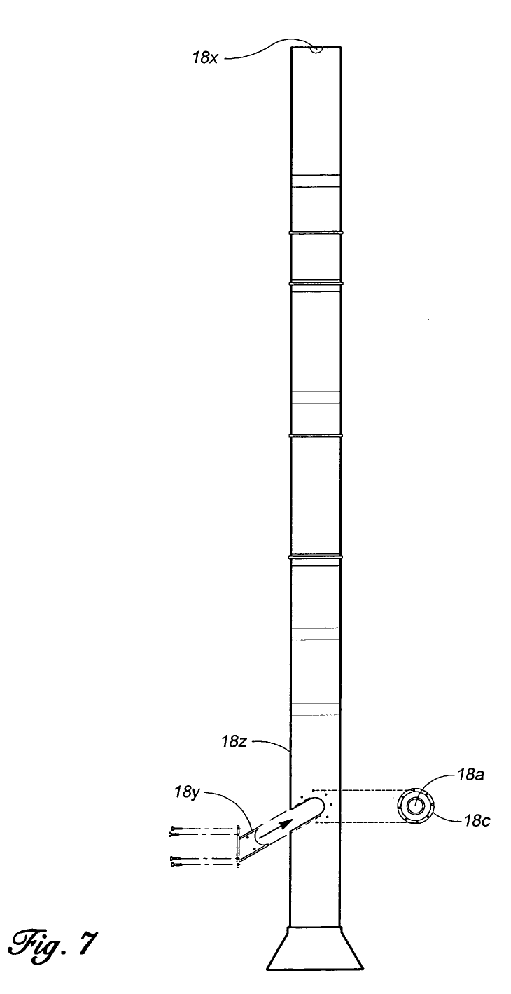

FIG. 6, FIG. 6A, and FIG. 6B illustrate the preferred embodiment of the displacing elements 21 and one embodiment of the linkage used to connect the oblate spheroid shaped displacers together to form the chain 20. While various displacer shapes can be employed, such as cylinders, spheres and conical variants the spheroid shape provides optimum performance, since as soon as a spheroid displacer is past tangent to the liquid seal 40 opening liquid is able to exert pressure upward, thus each element becomes buoyant as each passes tangent into the liquid column. The oblate spheroid displacer 21 is constructed having a sealed tubular opening 21u running through the center from top to bottom. Two recessed openings are located at either ends of the tubular opening 21u and serve as bearing races for the bearings 21t. A primary hinge 21z is permanently attached to the end of the linkage bar 21s which is inserted through a bearing 21t, through the center of the displacer 21, through the second bearing 21t and through the secondary hinge 21x; the secondary hinge 21x is attached to the end of the linkage bar 21s using a washer 21v and nut 21w. Displacers 21 are connected to each other using a bolt 21y, washer 21v and nut 21w which when connected form the linkages 20a that make up the chain 20. The oblate spheroid shape of the displacers 21 and linkages 20a are designed to have the same distance from center of linkage to center of linkage as the diameter of the displacer i.e. a 7 ft. wide displacer is 6 ft. 6 inches tall with center line of hinges located 3 inches above and 3 inches below the displacer, this minimizes nonlinear travel of the chain, avoids binding and allows free passage around the idler wheels. To reduce the wear rate at the hinges, the materials of construction for hinges 21x and 21z are to be non-metallic, while the bolt and nut may be made from stainless steel or other comparable material. The diameter of the idler wheels 13 and 14 is a function of diameter and radius of curvature of the displacers and length of the coupling links. The coupling links are as short as practical and recessed on both ends of the displacer to provide the densest displacer population in a given length of chain. Preferred material for displacing elements is light weight yet strong corrosion resistance and wear resistant stainless steel, composites of wound carbon fiber or thermoplastic polymers i.e. such as polyethylene terephthalate composites. Alternatively, displacers can be manufactured to have a vacuum inside, such that each displacer has no atmosphere to speak of, thus will not transfer heat internally. The best mode of implementation of the invention is a function of many considerations and one of the most important is size, shape and materials of construction of the displacer and connecting linkages.

FIG. 7, FIG. 7A, FIG. 7B and FIG. 8 illustrate the preferred embodiment for idle wheel bearing configurations, the shaft 18 of the idle wheel is female splined while the actual through wall shaft 18f is male splined. The main axial 18a bearings, main thrust bearings 18b and thrust bearing races 18c are inserted onto the shaft; the wheel is then installed and the thrust bearing races 18c are bolted in place. With the idle wheel bolted in position the male spline axle 18f is then installed from the outside of the enclosure 67 along with the remaining bearing components. The spline axle 18f has a secondary thrust bearing 18d, a secondary axial (steady) bearing 18g and labyrinth seals 18h. When the apparatus is fully loaded, revolutions per minute (rpm) of the axle shafts 18 and 18f will be low, therefore when 100% closed loop performance is required the labyrinth seals will be configured with a buffer gas seal system. Alternatively, any commercially available low rpm pressure seal design may be utilized in place of the labyrinth seal.

In the preferred embodiment of the labyrinth seal a small amount of dry buffer gas, from the recycle compressor discharge, is injected into the labyrinth seals 18h with direction of flow being from the outermost labyrinth, near the edge of the bearing race 18i, in toward the steady bearing 18g, where a low pressure return line routes the gas back to the recycle compressor suction; in this manner no liquid vapors escape into the environment.

In the one embodiment of idle wheel bearings, a water bearing design may be utilized for lower idle wheel 14 bearings 18a, 18b, 18d and 18g. Alternatively, the use of a commercially available electromagnetic bearing system may be utilized to eliminate friction at the idle wheel bearings.

In the preferred embodiment for attaching the lower idle wheel 14 to the support beams 18w and 18z, FIG. 7 and FIG. 7B illustrate how the wheel 14 must be hoisted in place at and upward angle (mechanical hoist installation), the idle wheel mount insert 18y is then bolted in place and finally the thrust bearing races 18c are bolted in place.

In the preferred embodiment for attaching the upper idle wheel 13 to the support beams 18w and 18z, FIG. 7 and FIG. 7A illustrate how the wheel 13 rests on top of the bearing race 60e just above the top bearing groove 18x. The wheel must be lifted in place (mechanical crane installation) with main axial bearings 18a resting inside the bearing race located at the top of the overhead liquid recycle tank sleeves 60e and the upper enclosure vessel 65 is then installed with said upper vessel 65 being comprised of the second half of the bearing race, the associated main bearing bolts and inserted from the bottom through the sleeve 60e mounting bracket then bolted into the upper vessel bearing mounting bracket and finally the thrust bearing races 18c are bolted in place. Alternatively, the upper idle wheel 13 may utilize a solid transaxle axle 18 to traverse the entire distance required for connecting to an external flywheel, gear or clutch plate assembly, such that the female spline in axle 18 and the through wall shaft 18f with male spline may be eliminated from the upper wheel 13 configuration.

FIG. 8 illustrates a typical installation as might be employed to provide electrical power to an industrial facility or location with toxic or arid environment. The size of the displaced liquid containment tank 12 and displacers in this application are large and dictated by the needs of the facility or community.

In the preferred embodiment of the invention the apparatus 10a can be operated in multiple modes including but not limited to: closed loop liquid recovery mode for arid and/or toxic environments, open system mode for clean environments where a naturally occurring source of fresh makeup water is readily available, dry gas seal mode where air is injected with fluid riser employed and liquid down-corner control valves closed, liquid seal mode where liquid down-corners are employed but no air is injected into the primary airlock 30a, liquid flood mode where liquid surrounds the lower idler wheel and the secondary airlock gas seal 42a is engaged as the main seal employed; in addition the apparatus can operate without the aid of internal fluid control by simply closing all the fluid control valves thus operating the apparatus as previously outlined in the parent U.S. Pat. No. 7,434,396 whereby pressurized gas is made available to seals for seal actuation. The closed loop system provides additional functionality for continued and safe operation under variable service conditions. In the preferred embodiment of the apparatus, load capacity can be adjusted by injecting a gas stream to beneficially manipulate fluid dynamics within the system i.e. instead of pumping out liquid level to decrease energy output of the apparatus, gas injection rate can be adjusted to increase or decrease internal fluid recycle rates, which in turn can be utilized to adjust the useful work output of the apparatus. In the preferred embodiment of the invention a computerized system is utilized and the system is fully automated through the use of control loops, which control fluid flow rates in order to maintain the targeted liquid levels, pressures and differential pressures within the system; an operator trained in the art can adjust the control parameters for the control loops, thereby optimizing the internal fluid dynamics to achieve peak performance of the apparatus under changing conditions, thereby increasing the useful work performed by the apparatus.

Referring to FIGS. 5, 5A-5D, in the preferred embodiment for startup of the “Enclosed Loop” Economy of Motion Machine, 10a, the vacuum isolation valve 84a is unblocked and the vacuum system is placed in service removing gas from the vapor recovery trap 84 at the top of tank 12 thus aiding the liquid fill process by inducing a partial vacuum in tank 12. If pressure in the seal gas drum 73 is low, compressor 97 is placed in service at this time using an auxiliary electric driver. If closed loop startup is desired, the recycle compressor 96 is placed in service at this time using an auxiliary electric driver. Two liquid filling startup methods are now available; the first method is to accomplish a “dry startup” when little to no liquid is present in the machine thus sequence is as follows: adjustable gas seals 42a, 42 and adjustable liquid seal 40 are fully engaged for tight closure around the displacing elements 21r, 21e and 21b. A liquid source is allowed to flow through the liquid makeup piping 95 by closing isolation valve 95b and opening liquid supply valve 95a; this routes liquid into the overhead liquid recycle tank 60 and via gravity flow through the liquid restriction chamber 68 into the liquid containment tank 12. As the liquid covers the top of primary airlock assembly 30a and starts to envelop the first displacer 21a the buoyancy of that displacer increases as the water rises around it. As more and more displacers are submerged, the speed and power of the machine increases until the water level in the tank reaches the maximum.

The second start up method is for a “wet restart” after the apparatus has been temporarily idle whereby the liquid collection tanks 15 and 15a have a full volume of stored liquid or when the apparatus has been operated in a liquid flood mode whereby the lower idle wheel enclosure vessel is flooded with liquid thus the sequence is as follows: all fluid circuits connected to the primary airlock assembly have control valves confirmed closed, then gas injection control valve 34d is opened injecting gas into the secondary airlock cavity 57, the secondary gas seal 42a is semi-engaged allowing a small flow of gas to pass upward into the gravity tube 66 and the primary airlock gas seal 42 and liquid seal 40 are fully disengaged (open); any liquid present in the tube 66 above the gas seal 42a will be allowed to pass downward through gas seal 42a under the influence of gravity. The lower idle wheel enclosure vessel 67 may remain liquid flooded, thus any excess liquid volume in vessel 67 will be transferred upward into the liquid tank 12 due to the differential pressure across seal 42a. If desired, the apparatus can be run in liquid flood mode at reduced load conditions by fully engaging gas seal 42 and liquid seal 40 at this time. If more liquid level is needed in tank 12 some of the liquid in the collection tanks 15 or 15a can be pressured out (or pumped out) by opening drain valves 91 and 91a or 92 and 92a, thus transferring liquid into the liquid recycle collector vent piping 29a, which routes the liquid into the overhead liquid recycle tank 60 and via gravity flow through the overhead liquid restriction chamber 68 into the liquid containment tank 12; as more and more displacers are submerged, the speed and power of the machine increases until the desired energy output is achieved. The lower idle wheel 14 can be designed to utilize water bearings, thus the apparatus can operate indefinitely with the lower idle wheel enclosure vessel 67 in liquid flood mode, but the preferred practice is to transition away from liquid flood conditions by storing any unused liquid inside the liquid collection tanks 15 and 15a, which have combined design capacities for storing a volume of liquid equal to the volume of the displaced liquid column 11. Regardless of the start up method used, once the apparatus is operating, and full load conditions are desired, all liquid in the lower idle wheel enclosure vessel is pressured out (or pumped out) via the liquid collection tanks 15, 15a by opening drain valves 91, 91a, 92 and 92a and fully engaging gas seal 42, 42a and liquid seal 40, thus transferring all available liquid back into the overhead liquid recycle tank 60. When liquid tank 12 is at maximum, as indicated by level sensor 12a, vacuum isolation valve 84a is blocked and vacuum pump 94 is shutdown, the seal gas compressor is placed on standby and the recycle compressor is switched from auxiliary electric driver to the normal service driver; the fluid control valves are now engaged allowing fluid risers 16 and liquid down-corners 19 to be placed in service, thus the machine is returned to normal operation and peak efficiency. The machine continues to run until seals fail or until purposefully stopped by either draining the displaced liquid containment tank 12 or by disengaging (opening) all seals and closing all control valves, thus allowing the liquid level in tank 12 to transfer into the lower idle wheel enclosure vessel 67 and into the gravity tube 66 through the disengaged secondary airlock seal 42a until all liquid levels are equalized.

To reduce material and energy losses due to friction the displacers and all mechanical contact points within the apparatus are to be coated with a low friction material. In addition, fixed equipment such as tubular opening, cavities and/or chambers, where contact with displacers occurs, are to be coated with ceramic material or other commercially available durable, abrasion resistant and low friction material such as surface coating (NFC) developed by Argonne National Laboratory as form of amorphous carbon with a friction coefficient of 0.001-0.006.

The differential pressure is greatest across the bottom opening 32 to the liquid tank 12 and the use of an electromagnetic system would ensure smoother transition through this region. This method of utilizing an electromagnetic field for propulsion is similar to what is in use today for magnetic trains and tubular magnetic accelerators, yet is novel in its configuration and application as described herein.

The following level of details is not depicted in the drawings provided: In an alternative embodiment of the liquid seal cavity 48, an electromagnetic assist seal 48m is utilized to induce linear induction through the tubular liquid seal cavity in order to provide an initial low-energy kick to each displacer as each enters the liquid column. The tubular cavity is itself non-metallic, such that the materials of construction for the liquid seal cavity 48 include a carbon fiber or ceramic lined wall within the seal cavity, a base structural support for said seal cavity with said support structure surrounding the seal cavity being primarily comprised of a non-magnetic metal alloy, thermoplastic composite or carbon fiber composite material ideally suited for encapsulating the components that make up the electromagnet 48m. To generate a strong magnetic field, electrical wire is wound in a coil around either the entrance or the exit of the tubular structure of the seal cavity 48 with said windings being wrapped about an iron core. A large voltage stored in capacitors is discharged rapidly into the coil providing sufficiently high currents resulting in a large magnetic field along the axis of the tube where the windings are located and polarity can be positive or negative depending on the location chosen; i.e., opposite polarity charge if located at the entrance to the seal cavity or like polarity charge if located at the seal cavity exit. The preferred materials of construction for the displacing elements 21 is a cobalt-base alloy that provides excellent magnetic properties combined with wear resistance and corrosion resistance. Stainless steel is essentially non-magnetic. In addition, nickel and iron alloys, as well as newly developing thermoplastic magnets, may be utilized in the construction of the displacing elements. The electromagnetic assist seal uses linear induction to aid in the process of injecting each displacer into the liquid column 11, by alternating/pulsing an electric current through the electrical windings thus alternating the magnetic field on and off as each elements 21 travels through the seal cavity 48; varying levels of thrust can be imparted to the magnetic displacing elements depending on the electrical input given, thus linear acceleration can be utilized to fine tune the travel speed of the displacing chain 20 and to reduce wear at the seals and idle wheel bearings. Alternatively, synchronous linear induction can be achieved if the magnetic field is constructed to allow the pulsating magnetic field to reverse polarity such that the displacers could be attracted into the liquid seal cavity 48 and then repelled into the liquid column 11. Using this method, the preferred materials of construction for the displacing elements 21 is stainless steel or carbon fiber composite bodies with a cobalt-base alloy band at tangent or at one end cap. Two coils would be utilized, one at the opening 32 to the liquid tank and the other at the opening to the liquid seal cavity 48; as the displacing elements approached each coiled zone they are accelerated towards it by an opposite polarity charge applied to that zone. As they pass tangent to the coiled zone, the polarity is switched so that the coil now repels them and they are accelerated by it towards the liquid column. A carefully controlled AC voltage is applied to each coil to continuously repeat this process for each displacing element.

While preferred embodiments of this invention have been illustrated and described, those trained in the art will understand and appreciate the existence of variations, combinations, and equivalents of the specific embodiment, methods, and examples herein. The invention should therefore not be limited by the above described embodiments, methods, and examples, but by all embodiments and methods within the scope and spirit of the invention as determined from the claims which follow.

What is claimed is:

1. A closed loop system for a buoyancy driven apparatus, comprising:
one or more tanks;
A quantity of working fluid tilling said tanks to at least a working level to thereby create columns of working fluid;
a plurality of tubes;
a plurality of chambers;
a plurality of sealing air locks;
a plurality of buoyant objects connected in an endless chain within said working fluid columns;
a plurality of piping circuits;
a plurality of control valves; and
means for integrally connecting said piping circuits within said tanks whereby said tubes, vessels, and air locks are fully encapsulated such that they are not exposed to the outside environment during normal operation and said working fluids are prevented from escaping into the outside environment.

2. An apparatus as defined by claim 1, wherein:
one of said sealing air locks is located in one of said tanks whereby said buoyant objects may vertically enter said working fluid at the bottom of said tank;
one of said sealing air locks located in the top of said one of said tanks; and
an idler wheel around which said buoyant objects pass after vertically leaving said working fluid through said sealing air lock located in the top of said one of said tanks.

3. An apparatus as defined by claim 1, further comprising means for adjusting modes of operation by adjusting said working fluid flow rates to and from said sealing air locks in response to mechanical wear or variable energy output demand; and
said means for adjusting modes of operation comprising said chambers, piping and control valves.

4. An apparatus as defined by claim 3, comprising:
means for balancing the differential forces across said sealing air locks comprising said chambers and said control valves.

5. An apparatus as defined by claim 4, further comprising an electromagnetic assist seal to induce linear induction through the tubular liquid seal cavity and thereby provide an initial impetus to each of said buoyant objects as each enters said working fluid columns.

6. A closed loop system for a buoyancy driven apparatus, comprising:
one or more tanks;
a plurality of buoyant objects;
A quantity of working fluid filling said tanks with columns of said working fluid to at least a working level;
a plurality of sealing air locks;
a plurality of buoyant objects entering and leaving said working fluid columns via said sealing air locks;
a controlled gas
a plurality of control valves for setting an injection rate for said controlled gas and feeding it at said rate into said sealing air locks; and
means for routing said controlled gas away from said columns of working fluid.

7. An apparatus as defined by claim 6, wherein:
said injected controlled gas decreases the liquid leak rate through said sealing air locks as a function of said injection rate,
an overhead liquid recovery tank, and
means for conducting heat away from said sealing air locks and transporting liquids present in the airlock cavity upward and into said overhead liquid recovery tank.

8. An apparatus as defined by claim 6, wherein said injected gas decreases the density of said working fluid at localized regions to balance forces across said sealing air locks and thereby reduce the force requirement for injecting said buoyant objects into one of said working fluid columns.

9. An apparatus as defined by claim 6, including:
overhead liquid recovery tank;
a liquid seal cavity located at the entrance to the bottom of said overhead liquid recovery tank turbulence promoter rings; and
said liquid flow reducers for supplying said working fluid below the location of said liquid seal cavity located at the entrance to the bottom of said overhead liquid recovery tank.

10. An apparatus as defined by claim 6, comprising:
means for injecting said controlled gas to beneficially manipulate differential pressure within said apparatus, induce turbulence in localized regions within said air locks and to beneficially disrupt laminar flow paths while providing liquid separation zones capable of diverting an upwardly mobile two phase fluid flow away from a column of liquid.

11. An apparatus as defined by claim 1, comprising:
means for utilizing said piping circuits, said control valves, said chambers and said tanks to provide a means for recovering and recycling said working fluid which escapes from one of said tanks back to said tank without the use of a liquid pump.

12. An apparatus as defined by claim 11, comprising:
heat exchanges within said piping circuits;
liquid separators within said piping circuits;
heat exchanges within said liquid separators; and
said heat exchanges comprise means for facilitating liquid recovery and delivery of said working fluid such that back flow prevention is addressed while maintaining minimal pressure drop for efficient vapor traffic upward throughout the system.

13. A closed loop system as defined by claim 12, comprising:
means for recycling escaping liquid present in said sealing air locks into said overhead liquid recovery tank:
a thermo-siphoning effect means for transferring said working fluid to an elevation higher than said sealing airlock:
said thermo-siphoning effect occurring as a result of heat rising within said piping circuits and rising gas bubbles carrying entrained liquid upward.

14. A closed loop system for a buoyancy driven apparatus as defined by claim 1, comprising:
a gas compressor; and
a mechanical coupling means driven by the motion of said endless chain for driving said gas compressor.

15. A closed loop system for a buoyancy driven apparatus as defined by claim 1, comprising:
an electricity producing means driven by the motion of said endless chain;
an electric motor powered by said electricity producing means; and
a gas compressor driven by said electric motor.

16. A closed loop system for a buoyancy driven apparatus as defined by claim 1, wherein said sealing air locks each include differential iris seals selected from the group of designs including designs utilizing a spring actuator, an air actuator or a buoyant float actuator.

17. A closed loop system for a buoyancy driven apparatus as defined by claim 2, wherein said air lock seals comprise:
a liquid differential seal at the entrance to the bottom of said tank containing said working fluid;
means for horizontally adjusting the opening of said liquid seal; and
means for adjusting the vertical position of said seal opening with respect to the bottom of said tank to facilitate injecting said buoyant objects through said seal opening.

18. A closed loop system for a buoyancy driven apparatus as defined by claim 2, wherein said air lock seals comprise:
means for dampening non-linear travel and vibrations of said endless chain, said means for dampening including a replaceable mechanical bellows for reducing mechanical wear on said sealing air locks and said idler wheels.

19. A closed loop system for a buoyancy driven apparatus, comprising:
one or more tanks;
a quantity of working fluid filling said tanks to at least a working level;
a plurality of buoyant objects connected in an endless chain within said working fluid contained within one of said tanks;
a plurality of air locks for admitting said endless chain into the bottom of said one of said tanks;
a plurality of control valves for minimizing working fluid loss as said buoyant objects pass through said air locks; and
work extracting means driven by the passage of said endless chain.

20. A closed loop system for a buoyancy driven apparatus as defined by claim 19 adapted to be used in pairs of said units wherein one of said units provides a backup function whereby an output of one of said work extracting means will always be available.
